(19) United States
(12) Patent Application Publication
(10) Pub. No.: US 2026/0113480 A1
(43) Pub. Date: Apr. 23, 2026

(54) ENCODING METHOD, DECODING METHOD, ENCODING DEVICE, AND DECODING DEVICE

(71) Applicant: Panasonic Intellectual Property Corporation of America, Torrance, CA (US)

(72) Inventors: Toshiyasu SUGIO, Osaka (JP); Noritaka IGUCHI, Osaka (JP); Takahiro NISHI, Nara (JP); Atsushi ITO, Osaka (JP)

(21) Appl. No.: 19/423,123

(22) Filed: Dec. 17, 2025

Related U.S. Application Data
(63) Continuation of application No. PCT/JP2024/022250, filed on Jun. 19, 2024.
(60) Provisional application No. 63/524,347, filed on Jun. 30, 2023.

(51) Int. Cl. H04N 19/54; H04N 19/105; H04N 19/139; H04N 19/172; H04N 19/196; H04N 19/513; H04N 19/577

(52) U.S. Cl. CPC H04N 19/54; H04N 19/105; H04N 19/139; H04N 19/172; H04N 19/196; H04N 19/521; H04N 19/577

(57) ABSTRACT

An encoding method according to an aspect of the present disclosure is an encoding method for encoding information of a three-dimensional point in a current frame to be encoded, and includes: selecting one or more reference three-dimensional points from among three-dimensional points in the current frame; and calculating, using first information of each of the one or more reference three-dimensional points, a predicted value of second information of a current three-dimensional point to be encoded in the current frame. In the selecting of the one or more reference three-dimensional points, the one or more reference three-dimensional points are selected based on distances between the current three-dimensional point and each of the three-dimensional points.

### CROSS REFERENCE TO RELATED APPLICATIONS

This is a continuation application of PCT International Application No. PCT/JP2024/022250 filed on Jun. 19, 2024, designating the United States of America, which is based on and claims priority of U.S. Provisional Patent Application No. 63/524,347 filed on Jun. 30, 2023. The entire disclosures of the above-identified applications, including the specifications, drawings and claims are incorporated herein by reference in their entirety.

### FIELD

The present disclosure relates to an encoding method, and so on.

### BACKGROUND

Patent Literature (PTL) 1 proposes a method and a device for encoding and decoding three-dimensional mesh data.

### CITATION LIST

### Patent Literature

Japanese Unexamined Patent Application Publication No. 2006-187015

### SUMMARY

### Technical Problem

There are demands for further improvement in processing of encoding or decoding three-dimensional data. The present disclosure improves processing of encoding or decoding three-dimensional data.

### Solution to Problem

An encoding method according to an aspect of the present disclosure is an encoding method for encoding information of a three-dimensional point in a current frame to be encoded, and includes: selecting one or more reference three-dimensional points from among three-dimensional points in the current frame; and calculating, using first information of each of the one or more reference three-dimensional points, a predicted value of second information of a current three-dimensional point to be encoded in the current frame. In the selecting of the one or more reference three-dimensional points, the one or more reference three-dimensional points are selected based on distances between the current three-dimensional point and each of the three-dimensional points.

It is to be noted that these general or specific aspects may be implemented as a system, a device, a method, an integrated circuit, a computer program, or a non-transitory recording medium such as a computer-readable CD-ROM, or may be implemented as any combination of a system, device, a method, an integrated circuit, a computer program, and a recording medium.

### Advantageous Effects

The present disclosure can contribute toward improving processing of encoding three-dimensional data and the like.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a conceptual diagram illustrating a three-dimensional mesh according to an embodiment.

FIG. 2 is a conceptual diagram illustrating basic elements of the three-dimensional mesh according to the embodiment.

FIG. 3 is a conceptual diagram illustrating mapping according to the embodiment.

FIG. 4 is a block diagram illustrating a configuration example of an encoding/decoding system according to the embodiment.

FIG. 5 is a block diagram illustrating a configuration example of an encoding device according to the embodiment.

FIG. 6 is a block diagram illustrating another configuration example of the encoding device according to the embodiment.

FIG. 7 is a block diagram illustrating a configuration example of a decoding device according to the embodiment.

FIG. 8 is a block diagram illustrating another configuration example of the decoding device according to the embodiment.

FIG. 9 is a conceptual diagram illustrating a configuration example of a bitstream according to the embodiment.

FIG. 10 is a conceptual diagram illustrating another configuration example of the bitstream according to the embodiment.

FIG. 11 is a conceptual diagram illustrating yet another configuration example of the bitstream according to the embodiment.

FIG. 12 is a block diagram illustrating a specific example of the encoding/decoding system according to the embodiment.

FIG. 13 is a conceptual diagram illustrating a configuration example of point cloud data according to the embodiment.

FIG. 14 is a conceptual diagram illustrating a data file example of the point cloud data according to the embodiment.

FIG. 15 is a conceptual diagram illustrating a configuration example of mesh data according to the embodiment.

FIG. 16 is a conceptual diagram illustrating a data file example of the mesh data according to the embodiment.

FIG. 17 is a conceptual diagram illustrating a type of three-dimensional data according to the embodiment.

FIG. 18 is a block diagram illustrating a configuration example of a three-dimensional data encoder according to the embodiment.

FIG. 19 is a block diagram illustrating a configuration example of a three-dimensional data decoder according to the embodiment.

FIG. 20 is a block diagram illustrating another configuration example of the three-dimensional data encoder according to the embodiment.

FIG. 21 is a block diagram illustrating another configuration example of the three-dimensional data decoder according to the embodiment.

FIG. 22 is a conceptual diagram illustrating a specific example of encoding processing according to the embodiment.

FIG. 23 is a conceptual diagram illustrating a specific example of decoding processing according to the embodiment.

FIG. 24 is a block diagram illustrating an implementation example of the encoding device according to the embodiment.

FIG. 25 is a block diagram illustrating an implementation example of the decoding device according to the embodiment.

FIG. 26 is a block diagram illustrating a configuration example of the encoding/decoding system according to the embodiment.

FIG. 27 is a block diagram illustrating another configuration example of the encoding device according to the embodiment.

FIG. 28 is a block diagram illustrating another configuration example of the decoding device according to the embodiment.

FIG. 29 is a block diagram illustrating yet another configuration example of the encoding device according to the embodiment.

FIG. 30 is a block diagram illustrating yet another configuration example of the decoding device according to the embodiment.

FIG. 31 is a block diagram illustrating a detailed configuration example of the decoding device according to the embodiment.

FIG. 32 is a diagram for describing coordinates of vertices in a three-dimensional mesh according to the embodiment.

FIG. 33 is a diagram for describing prediction information according to the embodiment.

FIG. 34 is an explanatory diagram illustrating an example of a mesh according to the embodiment.

FIG. 35 is an explanatory diagram illustrating an example of the division of a mesh into submeshes according to the embodiment.

FIG. 36 is a diagram for describing a positional relationship between three-dimensional points according to the embodiment.

FIG. 37 is a diagram for describing distances between three-dimensional points according to the embodiment.

FIG. 38 is a flowchart illustrating a selection process for adjacent points according to the embodiment.

FIG. 39 is a diagram for describing a selection process for adjacent points according to the embodiment.

FIG. 40 is a diagram illustrating a first example of reference destinations of motion groups according to the embodiment.

FIG. 41 is a diagram illustrating an example of a syntax of a base mesh header according to the embodiment.

FIG. 42 is a diagram illustrating a second example of reference destinations of motion groups according to the embodiment.

FIG. 43 is a diagram illustrating a third example of reference destinations of motion groups according to the embodiment.

FIG. 44 is a diagram for describing a relationship between vertices forming a mesh and a motion group according to the embodiment.

FIG. 45 is a diagram for describing a relationship between vertices forming submeshes and motion groups according to the embodiment.

FIG. 46 is a flowchart illustrating an example of a basic encoding process according to the embodiment.

FIG. 47 is a flowchart illustrating an example of a basic decoding process according to the embodiment.

### DESCRIPTION OF EMBODIMENTS

### <Outline of Present Disclosure>

Three-dimensional (3D) meshes are used in, for example, a computer graphics video. For example, the computer graphics video may include a plurality of frames different in time from one another, and each of the frames may be represented in the form of three-dimensional meshes.

The three-dimensional meshes each include vertex information indicating the positions of a plurality of vertices in a three-dimensional space, connection information indicating the connections between the plurality of vertices, and attribute information indicating attributes of the vertices or faces. The faces are each built in accordance with the connectivity relation among the plurality of vertices. Such three-dimensional meshes can represent various computer graphics videos.

For the transmission and storage of three-dimensional meshes, an efficient encoding and decoding of three-dimensional meshes is expected. For the efficient encoding and decoding of three-dimensional meshes, arithmetic encoding and arithmetic decoding may be used.

There is a demand for further improvement in an encoding or decoding process related to three-dimensional data. An object of the present disclosure is to improve the encoding or decoding process related to three-dimensional data.

Hereinafter, aspects of the invention derived from the content of the disclosure of the present description will be described by way of example, and the effects and the like derived from the aspect of the invention will be described.

An encoding method according to Example 1 is an encoding method for encoding information of a three-dimensional point in a current frame to be encoded. The encoding method includes: selecting one or more reference three-dimensional points from among three-dimensional points in the current frame; and calculating, using first information of each of the one or more reference three-dimensional points, a predicted value of second information of a current three-dimensional point to be encoded in the current frame. In the selecting of the one or more reference three-dimensional points, the one or more reference three-dimensional points are selected based on distances between the current three-dimensional point and each of the three-dimensional points.

It is considered that, as the distance between three-dimensional points is closer, the information of the three-dimensional points will also be closer. For this reason, for example, it is considered that, by calculating the predicted value using, as the reference three-dimensional point, a three-dimensional point that is close to a current three-dimensional point, the prediction residual can be reduced. If the prediction residual can be reduced, the amount of code of a bitstream including information on the prediction residual can be reduced. Therefore, by selecting one or more reference three-dimensional points, based on the distances between the current three-dimensional point and each of the three-dimensional points, the code amount can be reduced.

An encoding method according to Example 2 is the encoding method according to Example 1, that may further include: calculating a prediction residual that is a difference between a value indicated by the second information and the predicted value; and generating a bitstream that includes prediction residual information indicating the prediction residual calculated.

Accordingly, a bitstream having reduced code amount can be generated.

An encoding method according to Example 3 is the encoding method according to Example 1 or Example 2, in which: the first information of each of the one or more reference three-dimensional points may indicate a motion vector of each of the one or more reference three-dimensional points; and the second information may indicate a motion vector of the current three-dimensional point.

Accordingly, the motion vectors can be encoded.

An encoding method according to Example 4 is the encoding method according to any one of Example 1 to Example 3, in which: in the calculating of the predicted value, the predicted value may be calculated using inter prediction.

Accordingly, the predicted value can be calculated.

An encoding method according to Example 5 is the encoding method according to any one of Example 1 to Example 4, in which: in the selecting of the one or more reference three-dimensional points, the distances may be calculated by calculating a difference between coordinates of the current three-dimensional point and coordinates of each of the three-dimensional points.

Accordingly, the distances between the current three-dimensional point and each of the three-dimensional points can be calculated.

An encoding method according to Example 6 is the encoding method according to any one of Example 1 to Example 5, in which: in the selecting of the one or more reference three-dimensional points, one or more three-dimensional points for which the distances are less than or equal to a predetermined value may be selected as the one or more reference three-dimensional points, from among the three-dimensional points.

Accordingly, a three-dimensional point that is close to the current three-dimensional point can be selected from among the three-dimensional points.

An encoding method according to Example 7 is the encoding method according to any one of Example 1 to Example 6, in which: in the selecting of the one or more reference three-dimensional points, the one or more reference three-dimensional points may be selected by selecting, from among the three-dimensional points, a predetermined number of three-dimensional points in an ascending order of the distances.

Accordingly, an appropriate number of reference three-dimensional points for calculating the predicted value can be selected.

An encoding method according to Example 8 is the encoding method according to Example 7, that may further include: generating a bitstream that includes predetermined number information indicating the predetermined number.

Accordingly, a decoding device can select reference three-dimensional points by using the predetermined number information obtained from the bitstream.

An encoding method according to Example 9 is the encoding method according to any one of Example 1 to Example 8, in which: in the selecting of the one or more reference three-dimensional points, the distances may be calculated using coordinates of a three-dimensional point corresponding to the current three-dimensional point, in a reference frame.

Accordingly, the decoding device can calculate the distances in the same manner as the encoding device, without having to decode the coordinates of the current three-dimensional point in the current frame.

An encoding method according to Example 10 is the encoding method according to any one of Example 1 to Example 9, in which: the reference frame may be a frame that precedes the current frame in display order.

Accordingly, the current frame can be encoded by using a frame to be displayed in a display device earlier than the current frame, that is, by using a past frame.

An encoding method according to Example 11 is the encoding method according to Example 9, in which: the reference frame may be a frame that precedes the current frame in encoding order.

Accordingly, the current frame can be encoded using an encoded frame.

An encoding method according to Example 12 is the encoding method according to any one of Example 1 to Example 11, in which: in the selecting of the one or more reference three-dimensional points, the one or more reference three-dimensional points may be selected using the distances and information other than the distances.

Accordingly, since the information other than the distances are appropriately selected, the code amount can be further reduced.

An encoding method according to Example 13 is the encoding method according to Example 12, in which: the information other than the distances may be connection information indicating whether the current three-dimensional point is connected to each of the three-dimensional points; and, in the selecting of the one or more reference three-dimensional points, one or more three-dimensional points that are connected to the current three-dimensional point, among the three-dimensional points, may be selected as the one or more reference three-dimensional points.

In the case of three-dimensional points that are connected, it is considered that the information of such three-dimensional points will also be closer compared to three-dimensional points that are not connected. For this reason, for example, since it is considered that, by calculating the predicted value using, as the reference three-dimensional point, a three-dimensional point that is connected to the current three-dimensional point, the prediction residual can be reduced, and thus the code amount can be further reduced.

A decoding method according to Example 14 is a decoding method for decoding information of a three-dimensional point in a current frame to be decoded. The decoding method includes: selecting one or more reference three-dimensional points from among three-dimensional points in the current frame; and calculating, using first information of each of the one or more reference three-dimensional points, a predicted value of second information of a current three-dimensional point to be decoded in the current frame. In the selecting of the one or more reference three-dimensional points, the one or more reference three-dimensional points are selected based on distances between the current three-dimensional point and each of the three-dimensional points.

It is considered that, as the distance between three-dimensional points is closer, the information of the three-dimensional points will also be closer. For this reason, for example, it is considered that, by calculating the predicted value using, as the reference three-dimensional point, a three-dimensional point that is close to a current three-dimensional point, the prediction residual can be reduced. If the prediction residual can be reduced, the amount of code of a bitstream including information on the prediction residual can be reduced. Therefore, by selecting one or more reference three-dimensional points, based on the distances between the current three-dimensional point and each of the three-dimensional points, the information of the three-dimensional point can be decoded using information having reduced code amount.

A decoding method according to Example 15 is the decoding method according to Example 14, that may further include: obtaining, from a bitstream, prediction residual information indicating a prediction residual; and calculating the second information, based on the prediction residual and the predicted value.

Accordingly, the information of the three-dimensional point can be decoded using information of the bitstream having reduced code amount.

A decoding method according to Example 16 is the decoding method according to Example 14 or Example 15, in which: the first information of each of the one or more reference three-dimensional points may indicate a motion vector of each of the one or more reference three-dimensional points; and the second information may indicate a motion vector of the current three-dimensional point.

Accordingly, the motion vectors can be decoded.

A decoding method according to Example 17 is the decoding method according to any one of Example 14 to Example 16, in which: in the calculating of the predicted value, the predicted value may be calculated using inter prediction.

Accordingly, the predicted value can be calculated.

A decoding method according to Example 18 is the decoding method according to any one of Example 14 to Example 7, in which: in the selecting of the one or more reference three-dimensional points, the distances may be calculated by calculating a difference between coordinates of the current three-dimensional point and coordinates of each of the three-dimensional points.

Accordingly, the distances between the current three-dimensional point and each of the three-dimensional points can be calculated.

A decoding method according to Example 19 is the decoding method according to any one of Example 14 to Example 18, in which: in the selecting of the one or more reference three-dimensional points, one or more three-dimensional points for which the distances are less than or equal to a predetermined value may be selected as the one or more reference three-dimensional points, from among the three-dimensional points.

Accordingly, a three-dimensional point that is close to the current three-dimensional point can be selected from among the three-dimensional points.

A decoding method according to Example 20 is the decoding method according to any one of Example 14 to Example 19, in which: in the selecting of the one or more reference three-dimensional points, the one or more reference three-dimensional points may be selected by selecting, from among the three-dimensional points, a predetermined number of three-dimensional points in an ascending order of the distances.

Accordingly, an appropriate number of reference three-dimensional points for calculating the predicted value can be selected.

A decoding method according to Example 21 is the decoding method according to any one of Example 14 to Example 20, that may further include: obtaining, from a bitstream, predetermined number information indicating the predetermined number.

Accordingly, an appropriate number of reference three-dimensional points for calculating the predicted value can be selected, using the predetermined number information obtained from the bitstream.

A decoding method according to Example 22 is the decoding method according to any one of Example 14 to Example 21, in which: in the selecting of the one or more reference three-dimensional points, the distances may be calculated using coordinates of a three-dimensional point corresponding to the current three-dimensional point, in a reference frame.

Accordingly, the decoding device can calculate the distances in the same manner as the encoding device, without having to decode the coordinates of the current three-dimensional point in the current frame.

A decoding method according to Example 23 is the decoding method according to Example 22, in which: the reference frame may be a frame that precedes the current frame in display order.

Accordingly, the current frame can be decoded by using a frame to be displayed in a display device earlier than the current frame, that is, by using a past frame.

A decoding method according to Example 24 is the decoding method according to Example 22, in which: the reference frame may be a frame that precedes the current frame in encoding order.

Accordingly, the current frame can be decoded using a decoded frame.

A decoding method according to Example 25 is the decoding method according to any one of Example 14 to Example 24, in which: in the selecting of the one or more reference three-dimensional points, the one or more reference three-dimensional points may be selected using the distances and information other than the distances.

Accordingly, since the information other than the distances are appropriately selected, the information of the three-dimensional point can be decoded by using information having further reduced code amount.

A decoding method according to Example 26 is the decoding method according to Example 25, in which: the information other than the distances may be connection information indicating whether the current three-dimensional point is connected to each of the three-dimensional points; and, in the selecting of the one or more reference three-dimensional points, one or more three-dimensional points that are connected to the current three-dimensional point, among the three-dimensional points, may be selected as the one or more reference three-dimensional points.

In the case of three-dimensional points that are connected, it is considered that the information of such three-dimensional points will also be closer compared to three-dimensional points that are not connected. For this reason, for example, since it is considered that, by calculating the predicted value using, as the reference three-dimensional point, a three-dimensional point that is connected to the current three-dimensional point, the prediction residual can be reduced, the information of the three-dimensional point can be decoded by using information having further reduced code amount.

An encoding device according to Example 27 is an encoding device that encodes information of a three-dimensional point in a current frame to be encoded. The encoding device includes: memory; and a circuit having access to the memory. In operation, the circuit: selects one or more reference three-dimensional points from among three-dimensional points in the current frame; and calculates, using first information of each of the one or more reference three-dimensional points, a predicted value of second information of a current three-dimensional point to be encoded in the current frame. When selecting the one or more reference three-dimensional points, the circuit selects the one or more reference three-dimensional points, based on distances between the current three-dimensional point and each of the three-dimensional points.

Accordingly, the same advantageous effects as those of the encoding method according to Example 1 can be produced.

A decoding device according to Example 28 is a decoding device that decodes information of a three-dimensional point in a current frame to be decoded. The decoding device includes: memory; and a circuit capable of accessing the memory. In operation, the circuit: selects one or more reference three-dimensional points from among three-dimensional points in the current frame; and calculates, using first information of each of the one or more reference three-dimensional points, a predicted value of second information of a current three-dimensional point to be decoded in the current frame. When selecting the one or more reference three-dimensional points, the circuit selects the one or more reference three-dimensional points, based on distances between the current three-dimensional point and each of the three-dimensional points.

Accordingly, the same advantageous effects as those of the decoding method according to Example 14 can be produced.

Moreover, these general or specific aspects may be implemented using a system, a device, a method, an integrated circuit, a computer program, or a non-transitory computer-readable recording medium such as a CD-ROM, or any combination of systems, devices, methods, integrated circuits, computer programs, and recording media.

### Expressions and Terms

The following expressions and terms will be used herein.

### (1) Three-Dimensional Mesh

A three-dimensional mesh is a set of a plurality of faces and indicates, for example, a three-dimensional object. In addition, a three-dimensional mesh is mainly constituted of vertex information, connection information, and attribute information. A three-dimensional mesh may be expressed as a polygon mesh or a mesh. In addition, a three-dimensional mesh may have a temporal change. A three-dimensional mesh may include metadata related to vertex information, connection information, and attribute information or other additional information.

### (2) Vertex Information

Vertex information is information indicating a vertex. For example, vertex information indicates a position of a vertex in a three-dimensional space. In addition, a vertex corresponds to a vertex of a face that constitutes a three-dimensional mesh. Vertex information may be expressed as “geometry”. In addition, vertex information may also be expressed as position information.

### (3) Connection Information

Connection information is information indicating a connection between vertexes. For example, connection information indicates a connection for constructing a face or an edge of a three-dimensional mesh. Connection information may be expressed as “connectivity”. In addition, connection information may also be expressed as face information.

### (4) Attribute Information

Attribute information is information indicating an attribute of a vertex or a face. For example, attribute information indicates an attribute such as a color, an image, a normal vector, and the like associated with a vertex or a face. Attribute information may be expressed as “texture”.

### (5) Face

A face is an element that constitutes a three-dimensional mesh. Specifically, a face is a polygon on a plane in a three-dimensional space. For example, a face can be determined as a triangle in the three-dimensional space.

### (6) Plane

A plane is a two-dimensional plane in a three-dimensional space. For example, a polygon is formed on a plane and a plurality of polygons are formed on a plurality of planes.

### (7) Bitstream

A bitstream corresponds to encoded information. A bitstream can also be expressed as a stream, an encoded bitstream, a compressed bitstream, or an encoded signal.

### (8) Encoding and Decoding

The expression “encode” may be replaced with expressions such as store, include, write, describe, signalize, send out, notify, save, or compress and such expressions may be interchangeably used. For example, encoding information may mean including information in a bitstream. In addition, encoding information in a bitstream may mean encoding the information and generating a bitstream that includes the encoded information.

In addition, the expression “decode” may be replaced with expressions such as read, interpret, scan, load, derive, acquire, receive, extract, restore, reconstruct, decompress, or expand and such expressions may be interchangeably used. For example, decoding information may mean acquiring information from a bitstream. In addition, decoding information from a bitstream may mean decoding the bitstream and acquiring information included in the bitstream.

### (9) Ordinal Numbers

In the description, an ordinal number such as first, second, or the like may be affixed to a constituent element or the like. Such ordinal numbers may be replaced as necessary. In addition, an ordinal number may be newly affixed to or removed from a constituent element or the like. Furthermore, the ordinal numbers may be affixed to elements in order to identify the elements and may not correspond to any meaningful order.

### <Three-Dimensional Mesh>

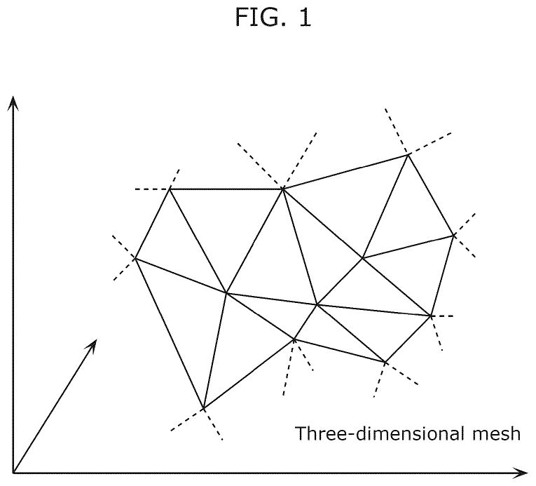

FIG. 1 is a conceptual diagram illustrating a three-dimensional mesh according to the present embodiment. The three-dimensional mesh is constituted of a plurality of faces. For example, each face is a triangle. Vertexes of the triangles are determined in a three-dimensional space. In addition, a three-dimensional mesh indicates a three-dimensional object. Each face may have a color or an image.

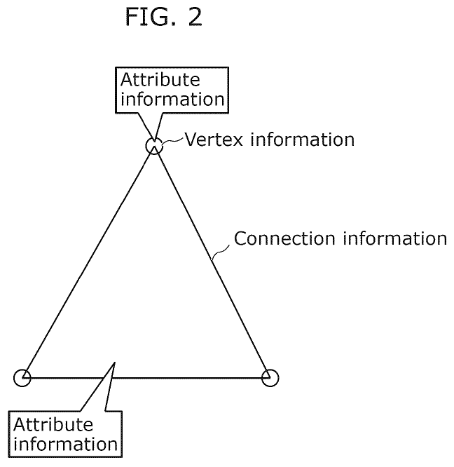

FIG. 2 is a conceptual diagram illustrating basic elements of a three-dimensional mesh according to the present embodiment. The three-dimensional mesh is constituted of vertex information, connection information, and attribute information. Vertex information indicates a position of a vertex of a face in a three-dimensional space. Connection information indicates a connection between vertexes. A face can be identified based on vertex information and connection information. In other words, an uncolored three-dimensional object is formed in a three-dimensional space based on vertex information and connection information.

Attribute information may be associated with a vertex or associated with a face. Attribute information associated with a vertex may be expressed as “attribute per point”. Attribute information associated with a vertex may indicate an attribute of the vertex itself or indicate an attribute of a face connected to the vertex.

For example, a color may be associated with a vertex as attribute information. The color associated with the vertex may be the color of the vertex or the color of a face connected to the vertex. The color of the face may be an average of a plurality of colors associated with a plurality of vertexes of the face. In addition, a normal vector may be associated with a vertex or a face as attribute information. Such a normal vector can express a front and a rear of a face.

In addition, a two-dimensional image may be associated with a face as attribute information. The two-dimensional image associated with a face is also expressed as a texture image or an “attribute map”. In addition, information indicating mapping between a face and a two-dimensional image may be associated with the face as attribute information. Such information indicating mapping may be expressed as mapping information, vertex information of a texture image, texture coordinates, or an “attribute UV coordinate”.

Furthermore, information on a color, an image, a moving image, and the like to be used as attribute information may be expressed as “parametric space”.

A texture is reflected in a three-dimensional object based on such attribute information. In other words, a colored three-dimensional object is formed in a three-dimensional space based on vertex information, connection information, and attribute information.

Note that while attribute information is associated with a vertex or a face in the description given above, alternatively, attribute information may be associated with an edge.

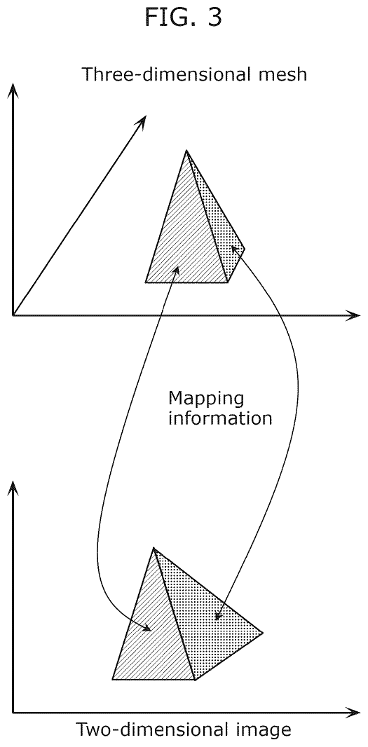

FIG. 3 is a conceptual diagram illustrating mapping according to the present embodiment. For example, a region of a two-dimensional image on a two-dimensional plane can be mapped to a face of a three-dimensional mesh in a three-dimensional space. Specifically, coordinate information of a region in the two-dimensional image is associated with a face of the three-dimensional mesh. Accordingly, an image of the mapped region in the two-dimensional image is reflected in the face of the three-dimensional mesh.

The use of mapping enables a two-dimensional image to be used as attribute information to be separated from the three-dimensional mesh. For example, in encoding of the three-dimensional mesh, the two-dimensional image may be encoded based on an image encoding system or a video encoding system.

### <System Configuration>

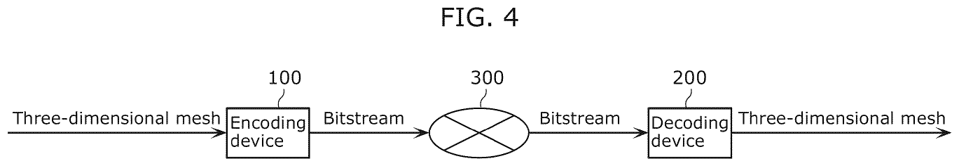

FIG. 4 is a block diagram illustrating a configuration example of an encoding/decoding system according to the present embodiment. In FIG. 4, the encoding/decoding system includes encoding device 100 and decoding device 200.

For example, encoding device 100 acquires a three-dimensional mesh and encodes the three-dimensional mesh into a bitstream. In addition, encoding device 100 outputs the bitstream to network 300. For example, the bitstream includes an encoded three-dimensional mesh and control information for decoding the encoded three-dimensional mesh. Encoding of the three-dimensional mesh causes information of the three-dimensional mesh to be compressed.

Network 300 transmits the bitstream from encoding device 100 to decoding device 200. Network 300 may be the Internet, a wide area network (WAN), a local area network (LAN), or a combination thereof. Network 300 is not necessarily limited to two-way communication and may be a unidirectional communication network for terrestrial digital broadcasting, satellite broadcasting, or the like.

In addition, network 300 may be replaced with a recording medium such as a DVD (digital versatile disc), a BD (Blu-Ray Disc (registered trademark)), or the like.

Decoding device 200 acquires a bitstream and decodes a three-dimensional mesh from the bitstream. Decoding of the three-dimensional mesh causes information of the three-dimensional mesh to be expanded. For example, decoding device 200 decodes a three-dimensional mesh according to a decoding method corresponding to an encoding method used by encoding device 100 to encode the three-dimensional mesh. In other words, encoding device 100 and decoding device 200 perform encoding and decoding according to an encoding method and a decoding method which correspond to each other.

Note that the three-dimensional mesh before encoding can also be expressed as an original three-dimensional mesh. In addition, the three-dimensional mesh after decoding is also expressed as a reconstructed three-dimensional mesh.

### <Encoding Device>

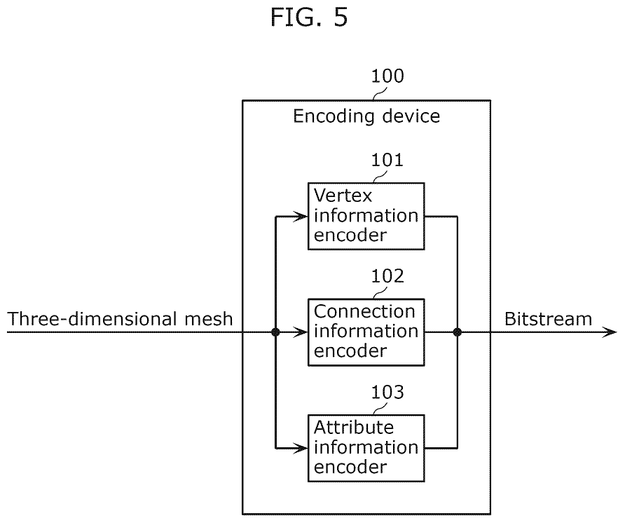

FIG. 5 is a block diagram illustrating a configuration example of encoding device 100 according to the present embodiment. For example, encoding device 100 includes vertex information encoder 101, connection information encoder 102, and attribute information encoder 103.

Vertex information encoder 101 is an electric circuit which encodes vertex information. For example, vertex information encoder 101 encodes vertex information into a bitstream according to a format defined with respect to the vertex information.

Connection information encoder 102 is an electric circuit which encodes connection information. For example, connection information encoder 102 encodes connection information into a bitstream according to a format defined with respect to the connection information.

Attribute information encoder 103 is an electric circuit which encodes attribute information. For example, attribute information encoder 103 encodes attribute information into a bitstream according to a format defined with respect to the attribute information.

Variable-length coding or fixed length coding may be used for encoding vertex information, connection information, and attribute information. The variable-length coding may accommodate Huffman coding, context-adaptive binary arithmetic coding (CABAC), or the like.

Vertex information encoder 101, connection information encoder 102, and attribute information encoder 103 may be integrated. Alternatively, each of vertex information encoder 101, connection information encoder 102, and attribute information encoder 103 may be more finely segmentalized into a plurality of constituent elements.

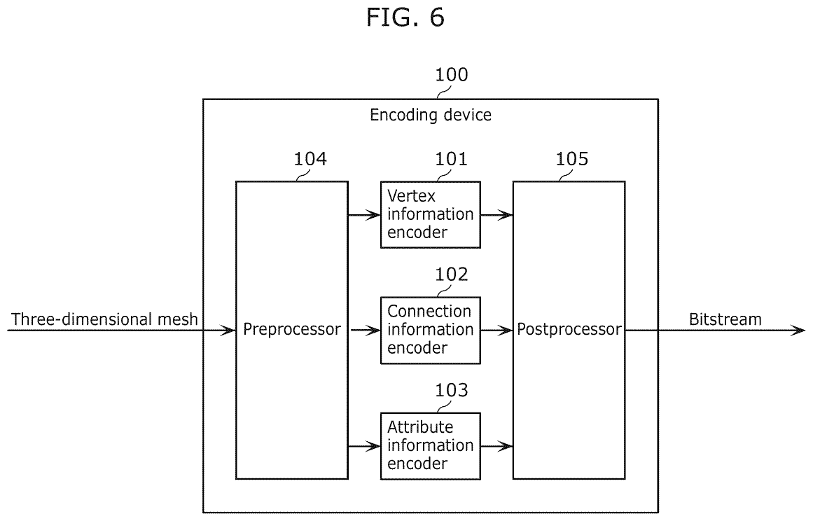

FIG. 6 is a block diagram illustrating another configuration example of encoding device 100 according to the present embodiment. For example, in addition to the components illustrated in FIG. 5, encoding device 100 includes preprocessor 104 and postprocessor 105.

Preprocessor 104 is an electric circuit which performs processing before encoding of vertex information, connection information, and attribute information. For example, preprocessor 104 may perform transformation processing, demultiplexing, multiplexing, or the like with respect to a three-dimensional mesh before encoding. More specifically, for example, preprocessor 104 may demultiplex vertex information, connection information, and attribute information from the three-dimensional mesh before encoding.

Postprocessor 105 is an electric circuit which performs processing after the encoding of vertex information, connection information, and attribute information. For example, postprocessor 105 may perform transformation processing, demultiplexing, multiplexing, or the like with respect to vertex information, connection information, and attribute information after encoding. More specifically, for example, postprocessor 105 may multiplex vertex information, connection information, and attribute information after encoding into a bitstream. In addition, for example, postprocessor 105 may further perform variable-length coding with respect to vertex information, connection information, and attribute information after the encoding.

### <Decoding Device>

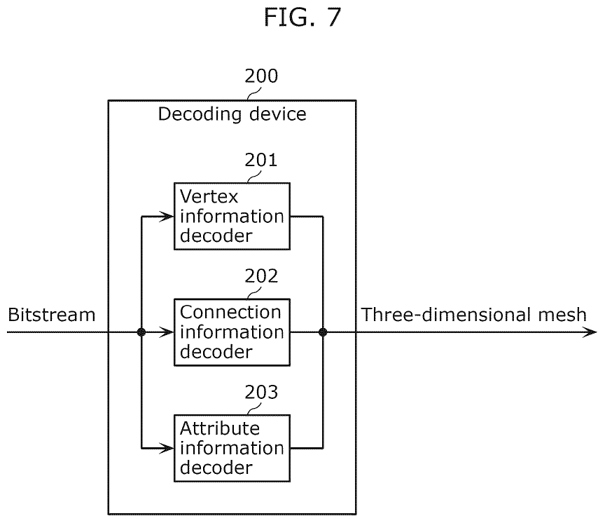

FIG. 7 is a block diagram illustrating a configuration example of decoding device 200 according to the present embodiment. For example, decoding device 200 includes vertex information decoder 201, connection information decoder 202, and attribute information decoder 203.

Vertex information decoder 201 is an electric circuit which decodes vertex information. For example, vertex information decoder 201 decodes vertex information from a bitstream according to a format defined with respect to the vertex information.

Connection information decoder 202 is an electric circuit which decodes connection information. For example, connection information decoder 202 decodes connection information from a bitstream according to a format defined with respect to the connection information.

Attribute information decoder 203 is an electric circuit which decodes attribute information. For example, attribute information decoder 203 decodes attribute information from a bitstream according to a format defined with respect to the attribute information.

Variable-length decoding or fixed length decoding may be used for decoding vertex information, connection information, and attribute information. The variable-length decoding may accommodate Huffman coding, context-adaptive binary arithmetic coding (CABAC), or the like.

Vertex information decoder 201, connection information decoder 202, and attribute information decoder 203 may be integrated. Alternatively, each of vertex information decoder 201, connection information decoder 202, and attribute information decoder 203 may be more finely segmentalized into a plurality of constituent elements.

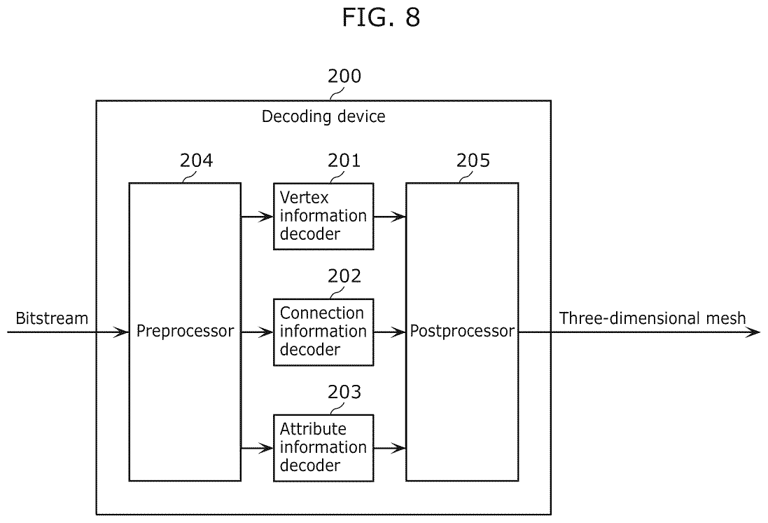

FIG. 8 is a block diagram illustrating another configuration example of decoding device 200 according to the present embodiment. For example, in addition to the components illustrated in FIG. 7, decoding device 200 includes preprocessor 204 and postprocessor 205.

Preprocessor 204 is an electric circuit which performs processing before decoding of vertex information, connection information, and attribute information. For example, preprocessor 204 may perform transformation processing, demultiplexing, multiplexing, or the like with respect to a bitstream before decoding of vertex information, connection information, and attribute information.

More specifically, for example, preprocessor 204 may demultiplex, from a bitstream, a sub-bitstream corresponding to vertex information, a sub-bitstream corresponding to connection information, and a sub-bitstream corresponding to attribute information. In addition, for example, preprocessor 204 may perform variable-length decoding with respect to the bitstream in advance before decoding of vertex information, connection information, and attribute information.

Postprocessor 205 is an electric circuit which performs processing after the decoding of vertex information, connection information, and attribute information. For example, postprocessor 205 may perform transformation processing, demultiplexing, multiplexing, or the like with respect to vertex information, connection information, and attribute information after decoding. More specifically, for example, postprocessor 205 may multiplex vertex information, connection information, and attribute information after decoding into a three-dimensional mesh.

### <Bitstream>

Vertex information, connection information, and attribute information are encoded and stored in a bitstream. A relationship between these pieces of information and the bitstream will be described below.

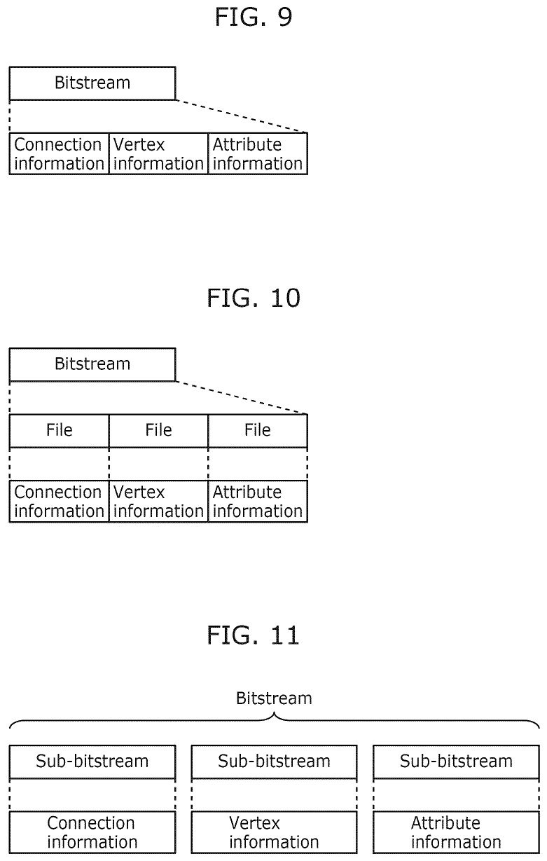

FIG. 9 is a conceptual diagram illustrating a configuration example of a bitstream according to the present embodiment. In this example, connection information, vertex information, and attribute information are integrated in the bitstream. For example, connection information, vertex information, and attribute information may be included in one file.

In addition, a plurality of portions of the pieces of information may be sequentially stored such as a first portion of connection information, a first portion of vertex information, a first portion of attribute information, a second portion of connection information, a second portion of vertex information, a second portion of attribute information, . . . . The plurality of portions may correspond to a plurality of temporally different portions, correspond to a plurality of spatially different portions, or correspond to a plurality of different faces.

Furthermore, an order of storage of connection information, vertex information, and attribute information is not limited to the example described above and an order of storage that differs from the above may be used.

FIG. 10 is a conceptual diagram illustrating another configuration example of a bitstream according to the present embodiment. In the example, a plurality of files are included in a bitstream and connection information, vertex information, and attribute information are respectively stored in different files. While a file including connection information, a file including vertex information, and a file including attribute information are illustrated here, storage formats are not limited to this example. For example, two types of information among connection information, vertex information, and attribute information may be included in one file and the one remaining type of information may be included in another file.

Alternatively, the pieces of information can be stored by being divided into a larger number of files. For example, a plurality of portions of connection information may be stored in a plurality of files, a plurality of portions of vertex information may be stored in a plurality of files, and a plurality of portions of attribute information may be stored in a plurality of files. The plurality of portions may correspond to a plurality of temporally different portions, correspond to a plurality of spatially different portions, or correspond to a plurality of different faces.

Furthermore, an order of storage of connection information, vertex information, and attribute information is not limited to the example described above and an order of storage that differs from the above may be used.

FIG. 11 is a conceptual diagram illustrating another configuration example of a bitstream according to the present embodiment. In the example, a bitstream is constituted of a plurality of separable sub-bitstreams and connection information, vertex information, and attribute information are respectively stored in different sub-bitstreams.

While a sub-bitstream including connection information, a sub-bitstream including vertex information, and a sub-bitstream including attribute information are illustrated here, storage formats are not limited to this example.

For example, two types of information among connection information, vertex information, and attribute information may be included in one sub-bitstream and the one remaining type of information may be included in another sub-bitstream. Specifically, attribute information such as a two-dimensional image may be stored in a sub-bitstream conforming to an image coding system separately from a sub-bitstream of connection information and vertex information.

In addition, each sub-bitstream may include a plurality of files. Furthermore, a plurality of portions of connection information may be stored in a plurality of files, a plurality of portions of vertex information may be stored in a plurality of files, and a plurality of portions of attribute information may be stored in a plurality of files.

Furthermore, an order of storage of connection information, vertex information, and attribute information is not limited to the example illustrated in FIG. 9, FIG. 10, and FIG. 11, and an order of storage that differs from this example may be used. For example, vertex information, connection information, and attribute information may be stored in a bitstream in this order. Alternatively, in an order other than this order, e.g., in any of orders: connection information, attribute information, and vertex information; vertex information, attribute information, and connection information; attribute information, connection information, and vertex information; and attribute information, vertex information, and connection information, these pieces of information may be stored in a bitstream.

Furthermore, each of connection information, vertex information, and attribute information may be divided into a plurality of data items, and the plurality of data items may be stored in a bitstream in a periodic order or in a random order.

### Specific Example

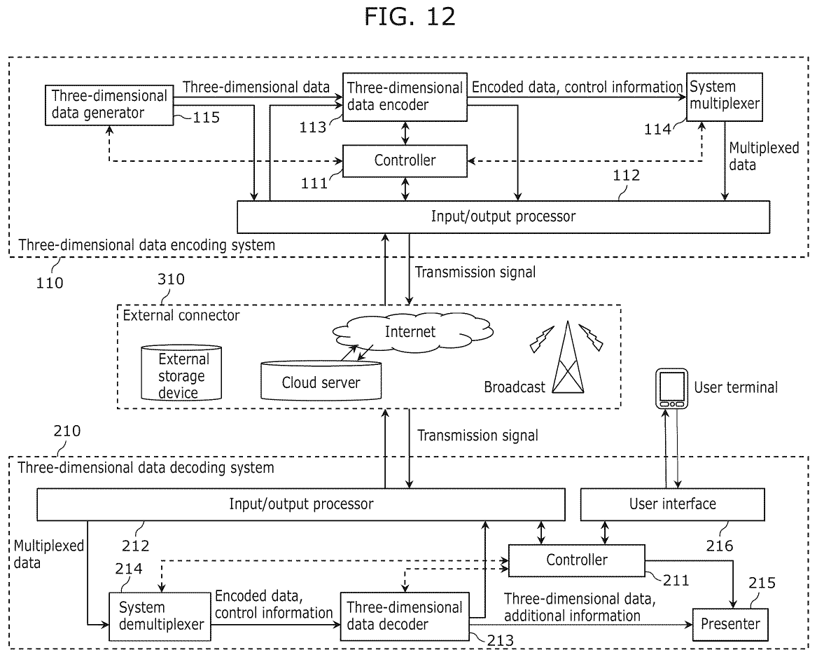

FIG. 12 is a block diagram illustrating a specific example of the encoding/decoding system according to the present embodiment. In FIG. 12, the encoding/decoding system includes three-dimensional data encoding system 110, three-dimensional data decoding system 210, and external connector 310.

Three-dimensional data encoding system 110 includes controller 111, input/output processor 112, three-dimensional data encoder 113, three-dimensional data generator 115, and system multiplexer 114. Three-dimensional data decoding system 210 includes controller 211, input/output processor 212, three-dimensional data decoder 213, system demultiplexer 214, presenter 215, and user interface 216.

In three-dimensional data encoding system 110, sensor data is input from a sensor terminal to three-dimensional data generator 115. Three-dimensional data generator 115 generates three-dimensional data that is point cloud data, mesh data, or the like from the sensor data and inputs the three-dimensional data to three-dimensional data encoder 113.

For example, three-dimensional data generator 115 generates vertex information and generates connection information and attribute information which correspond to the vertex information. Three-dimensional data generator 115 may process vertex information when generating connection information and attribute information. For example, three-dimensional data generator 115 may reduce a data amount by deleting overlapping vertexes or transform vertex information (position shift, rotation, normalization, or the like). In addition, three-dimensional data generator 115 may render attribute information.

While three-dimensional data generator 115 is a constituent element of three-dimensional data encoding system 110 in FIG. 12, three-dimensional data generator 115 may be disposed on the outside independent of three-dimensional data encoding system 110.

For example, a sensor terminal that provides sensor data for generating three-dimensional data may be a mobile object such as an automobile, a flying object such as an airplane, a mobile terminal, a camera, or the like. Alternatively, a range sensor such as LIDAR, a millimeter-wave radar, an infrared sensor, or a range finder, a stereo camera, a combination of a plurality of monocular cameras, or the like may be used as the sensor terminal.

The sensor data may be a distance (position) of an object, a monocular camera image, a stereo camera image, a color, a reflectance, an attitude or an orientation of a sensor, a gyro, a sensing position (GPS information or elevation), a velocity, an acceleration, a time of day of sensing, air temperature, air pressure, humidity, magnetism, or the like.

Three-dimensional data encoder 113 corresponds to encoding device 100 illustrated in FIG. 5 and the like. For example, three-dimensional data encoder 113 encodes three-dimensional data and generates encoded data. In addition, three-dimensional data encoder 113 generates control information when encoding the three-dimensional data. Furthermore, three-dimensional data encoder 113 inputs the encoded data to system multiplexer 114 together with the control information.

The encoding system of three-dimensional data may be an encoding system using geometry or an encoding system using a video codec. In this case, an encoding system using geometry may also be expressed as a geometry-based encoding system. An encoding system using a video codec may also be expressed as a video-based encoding system.

System multiplexer 114 multiplexes encoded data and control information input from three-dimensional data encoder 113 and generates multiplexed data using a prescribed multiplexing system. System multiplexer 114 may multiplex other media such as video, audio, subtitles, application data, or document files, reference time information, or the like together with the encoded data and control information of three-dimensional data. Furthermore, system multiplexer 114 may multiplex attribute information related to sensor data or three-dimensional data.

For example, multiplexed data has a file format for accumulation, a packet format for transmission, or the like. ISOBMFF or an ISOBMFF-based system may be used as an accumulation system or a transmission system. Alternatively, MPEG-DASH, MMT, MPEG-2 TS Systems, RTP, or the like may be used.

In addition, multiplexed data is output as a transmission signal by input/output processor 112 to external connector 310. The multiplexed data may be transmitted as a transmission signal in a wired manner or in a wireless manner. Alternatively, the multiplexed data is accumulated in an internal memory or a storage device. The multiplexed data may be transmitted via the Internet to a cloud server or stored in an external storage device.

For example, the transmission or accumulation of the multiplexed data is performed by a method in accordance with a medium for transmission or accumulation such as broadcasting or communication. As a communication protocol, http, ftp, TCP, UDP, IP, or a combination thereof may be used. In addition, a pull-type communication scheme may be used or a push-type communication scheme may be used.

Ethernet (registered trademark), USB, RS-232C, HDMI (registered trademark), a coaxial cable, or the like may be used for wired transmission. In addition, 3GPP (registered trademark), 3G/4G/5G as specified by IEEE, a wireless LAN, Bluetooth, or a millimeter-wave may be used for wireless transmission. Furthermore, for example, DVB-T2, DVB-S2, DVB-C2, ATSC 3.0, ISDB-S3, or the like may be used as a broadcasting system.

Note that sensor data may be input to three-dimensional data generator 115 or system multiplexer 114. In addition, three-dimensional data or encoded data may be output as-is as a transmission signal to external connector 310 via input/output processor 112. The transmission signal output from three-dimensional data encoding system 110 is input to three-dimensional data decoding system 210 via external connector 310.

In addition, each operation of three-dimensional data encoding system 110 may be controlled by controller 111 which executes application programs.

In three-dimensional data decoding system 210, a transmission signal is input to input/output processor 212. Input/output processor 212 decodes multiplexed data having a file format or a packet format from the transmission signal and inputs the multiplexed data to system demultiplexer 214. System demultiplexer 214 acquires encoded data and control information from the multiplexed data and inputs the encoded data and the control information to three-dimensional data decoder 213. System demultiplexer 214 may extract other media, reference time information, or the like from the multiplexed data.

Three-dimensional data decoder 213 corresponds to decoding device 200 illustrated in FIG. 7 and the like. For example, three-dimensional data decoder 213 decodes three-dimensional data from the encoded data based on an encoding system specified in advance. Subsequently, the three-dimensional data is presented to a user by presenter 215.

In addition, additional information such as sensor data may be input to presenter 215. Presenter 215 may present three-dimensional data based on the additional information. In addition, an instruction by the user may be input to user interface 216 from a user terminal. Furthermore, presenter 215 may present three-dimensional data based on the input instruction.

Note that input/output processor 212 may acquire three-dimensional data and encoded data from external connector 310.

In addition, each operation of three-dimensional data decoding system 210 may be controlled by controller 211 which executes application programs.

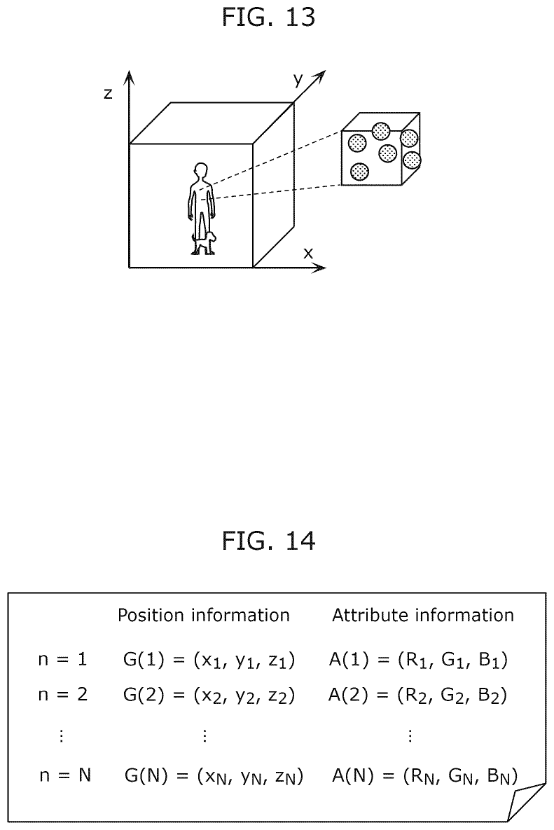

FIG. 13 is a conceptual diagram illustrating a configuration example of point cloud data according to the present embodiment. Point cloud data refers to data of a point cloud that indicates a three-dimensional object.

Specifically, a point cloud is constituted of a plurality of points and has position information which indicates a three-dimensional coordinate position of each point and attribute information which indicates an attribute of each point. The position information is also expressed as geometry.

For example, a type of attribute information may be a color, a reflectance, or the like. Attribute information related to one type may be associated with one point, attribute information related to a plurality of different types may be associated with one point, or attribute information having a plurality of values with respect to a same type may be associated with one point.

FIG. 14 is a conceptual diagram illustrating a data file example of the point cloud data according to the present embodiment. The example is an example of a case where items of position information and items of attribute information have a one-to-one correspondence and the example indicates position information and attribute information of N-number of points which constitute the point cloud data. In this example, position information is information indicating a three-dimensional coordinate position by three axes of x, y, and z and attribute information is information indicating a color by RGB. As a representative data file of point cloud data, a PLY file or the like can be used.

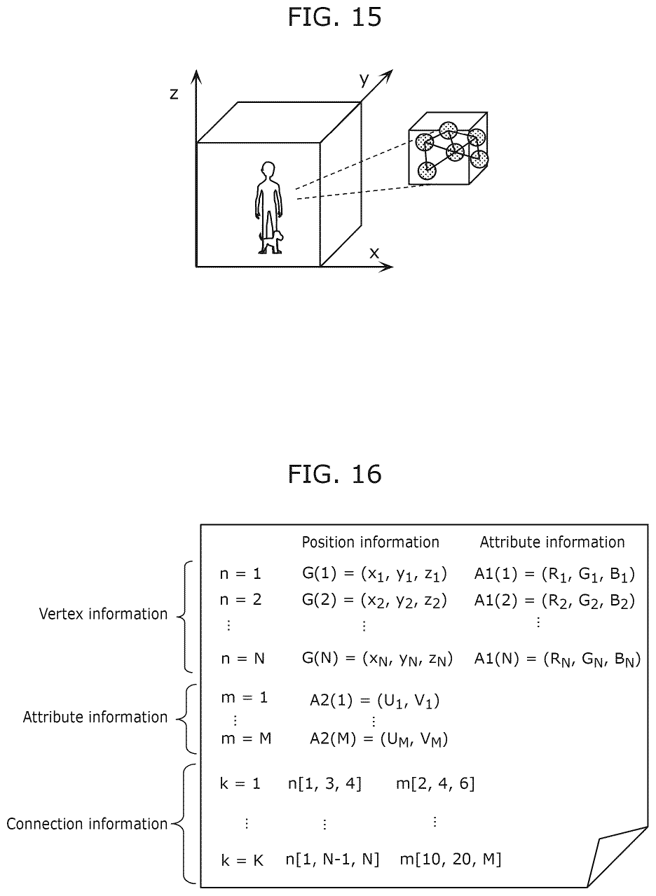

FIG. 15 is a conceptual diagram illustrating a configuration example of mesh data according to the present embodiment. Mesh data is data used in CG (computer graphics) or the like and is data of a three-dimensional mesh which represents a three-dimensional shape of an object by a plurality of faces. Each face is also expressed as a polygon and has a polygonal shape such as a triangle or a quadrilateral.

Specifically, in addition to the plurality of points which constitute a point cloud, a three-dimensional mesh is constituted of a plurality of edges and a plurality of faces. Each point is also expressed as a vertex or a position. Each edge corresponds to a line segment which connects two vertexes. Each face corresponds to an area enclosed by three or more edges.

In addition, a three-dimensional mesh has position information indicating three-dimensional coordinate positions of vertexes. The position information is also expressed as vertex information or geometry. Furthermore, a three-dimensional mesh has connection information indicating a relationship among a plurality of vertexes constituting an edge or a face. The connection information is also expressed as connectivity. In addition, a three-dimensional mesh has attribute information indicating an attribute with respect to a vertex, an edge, or a face. The attribute information in a three-dimensional mesh is also expressed as a texture.

For example, attribute information may indicate a color, a reflectance, or a normal vector with respect to a vertex, an edge, or a face. An orientation of a normal vector can express a front and a rear of a face.

An object file or the like may be used as a data file format of mesh data.

FIG. 16 is a conceptual diagram illustrating a data file example of the mesh data according to the present embodiment. In the example, a data file includes pieces of position information G(1) to G(N) and pieces of attribute information A1(1) to A1(N) of N-number of vertexes which constitute a three-dimensional mesh. In addition, in the example, M-number of pieces of attribute information A2(1) to A2(M) are included. An item of attribute information need not correspond one-to-one to a vertex and need not correspond one-to-one to a face. In addition, attribute information need not exist.

Connection information is indicated by a combination of indexes of vertexes. n [1, 3, 4] indicates a face of a triangle constituted of three vertexes n=1, n=3, and n=4. In addition, m [2, 4, 6] indicates that pieces of attribute information m=2, m=4, and M=6 respectively correspond to the three vertexes.

In addition, a substantive content of the attribute information may be described in a separate file. Furthermore, a pointer with respect to the content may be associated with a vertex, a face, or the like. For example, attribute information indicating an image with respect to a face may be stored in a two-dimensional attribute map file. In addition, a file name of the attribute map and a two-dimensional coordinate value in the attribute map may be described in pieces of attribute information A2(1) to A2(M). Methods of designating attribute information with respect to a face are not limited to these methods and any kind of method may be used.

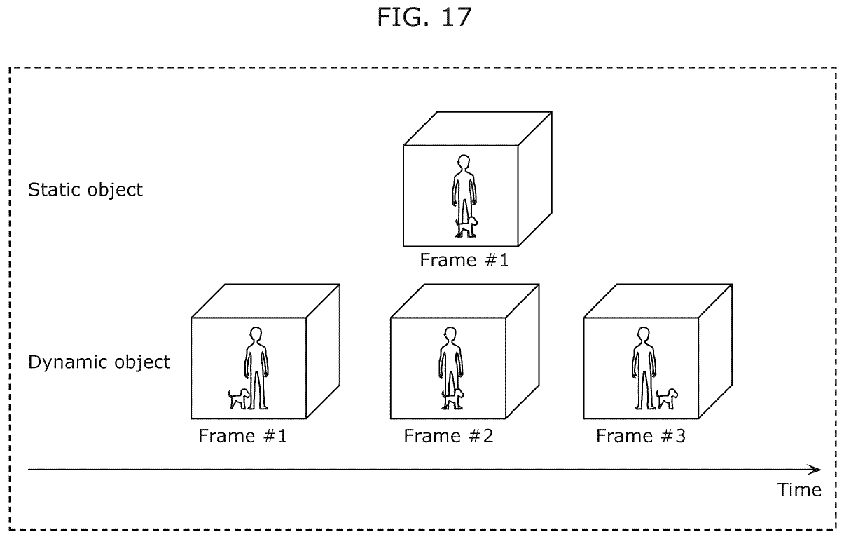

FIG. 17 is a conceptual diagram illustrating a type of three-dimensional data according to the present embodiment. Point cloud data and mesh data may either indicate a static object or a dynamic object. A static object is an object that does not temporally change and a dynamic object is an object that temporally changes. A static object may correspond to three-dimensional data with respect to an arbitrary time point.

For example, point cloud data with respect to an arbitrary time point may be expressed as a PCC frame. In addition, mesh data with respect to an arbitrary time point may be expressed as a mesh frame. Furthermore, a PCC frame and a mesh frame may be simply expressed as a frame.

In addition, an area of an object may be limited to a certain range in a similar manner to ordinary video data or need not be limited in a similar manner to map data. Furthermore, a density of points or faces may be set in various ways. Sparse point cloud data or sparse mesh data may be used or dense point cloud data or dense mesh data may be used.

Next, encoding and decoding of a point cloud or a three-dimensional mesh will be described. A device, processing, or a syntax for encoding and decoding vertex information of a three-dimensional mesh according to the present disclosure may be applied to the encoding and decoding of a point cloud. A device, processing, or a syntax for encoding and decoding a point cloud according to the present disclosure may be applied to the encoding and decoding of vertex information of a three-dimensional mesh.

In addition, a device, processing, or a syntax for encoding and decoding attribute information of a point cloud according to the present disclosure may be applied to the encoding and decoding of connection information or attribute information of a three-dimensional mesh. Furthermore, a device, processing, or a syntax for encoding and decoding connection information or attribute information of a three-dimensional mesh according to the present disclosure may be applied to the encoding and decoding of attribute information of a point cloud.

Furthermore, at least a part of processing may be commonalized between the encoding and decoding of point cloud data and the encoding and decoding of mesh data. Accordingly, sizes of circuits and software programs can be suppressed.

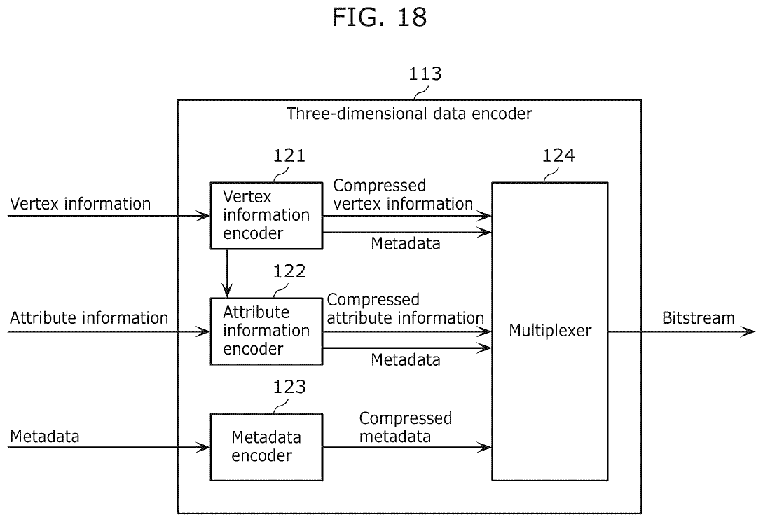

FIG. 18 is a block diagram illustrating a configuration example of three-dimensional data encoder 113 according to the present embodiment. In this example, three-dimensional data encoder 113 includes vertex information encoder 121, attribute information encoder 122, metadata encoder 123, and multiplexer 124. Vertex information encoder 121, attribute information encoder 122, and multiplexer 124 may correspond to vertex information encoder 101, attribute information encoder 103, postprocessor 105, and the like illustrated in FIG. 6.

In addition, in this example, three-dimensional data encoder 113 encodes three-dimensional data according to a geometry-based encoding system. Encoding according to the geometry-based encoding system takes a three-dimensional structure into consideration. Furthermore, in encoding according to the geometry-based encoding system, attribute information is encoded using configuration information obtained during encoding of vertex information.

Specifically, first, vertex information, attribute information, and metadata included in three-dimensional data generated from sensor data are respectively input to vertex information encoder 121, attribute information encoder 122, and metadata encoder 123. In this case, connection information included in three-dimensional data may be handled in a similar manner to attribute information. In addition, in the case of point cloud data, position information may be handled as vertex information.

Vertex information encoder 121 encodes vertex information into compressed vertex information and outputs the compressed vertex information to multiplexer 124 as encoded data. In addition, vertex information encoder 121 generates metadata of the compressed vertex information and outputs the metadata to multiplexer 124. Furthermore, vertex information encoder 121 generates configuration information and outputs the configuration information to attribute information encoder 122.

Attribute information encoder 122 encodes attribute information into compressed attribute information using the configuration information generated by vertex information encoder 121 and outputs the compressed attribute information to multiplexer 124 as encoded data. In addition, attribute information encoder 122 generates metadata of the compressed attribute information and outputs the metadata to multiplexer 124.

Metadata encoder 123 encodes compressible metadata into compressed metadata and outputs the compressed metadata to multiplexer 124 as encoded data. The metadata encoded by metadata encoder 123 may be used to encode vertex information and to encode attribute information.

Multiplexer 124 multiplexes the compressed vertex information, the metadata of the compressed vertex information, the compressed attribute information, the metadata of the compressed attribute information, and the compressed metadata into a bitstream. In addition, multiplexer 124 inputs the bitstream into a system layer.

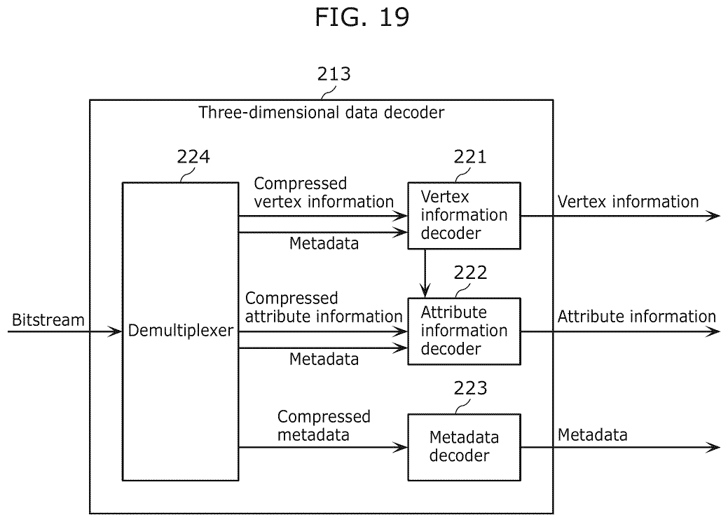

FIG. 19 is a block diagram illustrating a configuration example of three-dimensional data decoder 213 according to the present embodiment. In this example, three-dimensional data decoder 213 includes vertex information decoder 221, attribute information decoder 222, metadata decoder 223, and demultiplexer 224. Vertex information decoder 221, attribute information decoder 222, and demultiplexer 224 may correspond to vertex information decoder 201, attribute information decoder 203, preprocessor 204, and the like illustrated in FIG. 8.

In addition, in this example, three-dimensional data decoder 213 decodes three-dimensional data according to a geometry-based encoding system. Decoding according to the geometry-based encoding system takes a three-dimensional structure into consideration. Furthermore, in decoding according to the geometry-based encoding system, attribute information is decoded using configuration information obtained during decoding of vertex information.

Specifically, first, a bitstream is input from a system layer into demultiplexer 224. Demultiplexer 224 separates compressed vertex information, metadata of the compressed vertex information, compressed attribute information, metadata of the compressed attribute information, and compressed metadata from the bitstream. The compressed vertex information and the metadata of the compressed vertex information are input to vertex information decoder 221. The compressed attribute information and the metadata of the compressed attribute information are input to attribute information decoder 222. The metadata is input to metadata decoder 223.

Vertex information decoder 221 decodes vertex information from the compressed vertex information using the metadata of the compressed vertex information. In addition, vertex information decoder 221 generates configuration information and outputs the configuration information to attribute information decoder 222. Attribute information decoder 222 decodes attribute information from the compressed attribute information using the configuration information generated by vertex information decoder 221 and the metadata of the compressed attribute information. Metadata decoder 223 decodes metadata from the compressed metadata. The metadata decoded by metadata decoder 223 may be used to decode vertex information and to decode attribute information.

Subsequently, the vertex information, the attribute information, and the metadata are output from three-dimensional data decoder 213 as three-dimensional data. For example, the metadata is metadata of vertex information and attribute information and can be used in an application program.

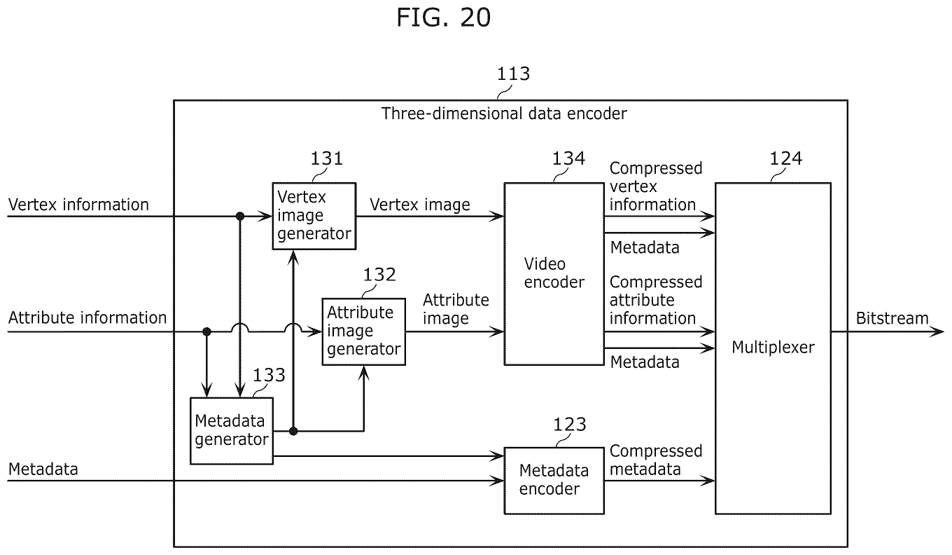

FIG. 20 is a block diagram illustrating another configuration example of three-dimensional data encoder 113 according to the present embodiment. In this example, three-dimensional data encoder 113 includes vertex image generator 131, attribute image generator 132, metadata generator 133, video encoder 134, metadata encoder 123, and multiplexer 124. Vertex image generator 131, attribute image generator 132, and video encoder 134 may correspond to vertex information encoder 101, attribute information encoder 103, and the like illustrated in FIG. 6.

In addition, in this example, three-dimensional data encoder 113 encodes three-dimensional data according to a video-based encoding system. In encoding according to the video-based encoding system, a plurality of two-dimensional images are generated from three-dimensional data and the plurality of two-dimensional images are encoded according to a video encoding system. In this case, the video encoding system may be HEVC (high efficiency video coding), VVC (versatile video coding), or the like.

Specifically, first, vertex information and attribute information included in three-dimensional data generated from sensor data are input to metadata generator 133. In addition, the vertex information and the attribute information are respectively input to vertex image generator 131 and attribute image generator 132. Furthermore, the metadata included in the three-dimensional data is input to metadata encoder 123. In this case, connection information included in three-dimensional data may be handled in a similar manner to attribute information. In addition, in the case of point cloud data, position information may be handled as vertex information.

Metadata generator 133 generates map information of a plurality of two-dimensional images from the vertex information and the attribute information. In addition, metadata generator 133 inputs the map information into vertex image generator 131, attribute image generator 132, and metadata encoder 123.

Vertex image generator 131 generates a vertex image based on the vertex information and the map information and inputs the vertex image into video encoder 134. Attribute image generator 132 generates an attribute image based on the attribute information and the map information and inputs the attribute image into video encoder 134.

Video encoder 134 respectively encodes the vertex image and the attribute image into compressed vertex information and compressed attribute information according to the video encoding system and outputs the compressed vertex information and the compressed attribute information to multiplexer 124 as encoded data. In addition, video encoder 134 generates metadata of the compressed vertex information and metadata of the compressed attribute information and outputs the pieces of metadata to multiplexer 124.

Metadata encoder 123 encodes compressible metadata into compressed metadata and outputs the compressed metadata to multiplexer 124 as encoded data. Compressible metadata includes map information. In addition, the metadata encoded by metadata encoder 123 may be used to encode vertex information and to encode attribute information.

Multiplexer 124 multiplexes the compressed vertex information, the metadata of the compressed vertex information, the compressed attribute information, the metadata of the compressed attribute information, and the compressed metadata into a bitstream. In addition, multiplexer 124 inputs the bitstream into a system layer.

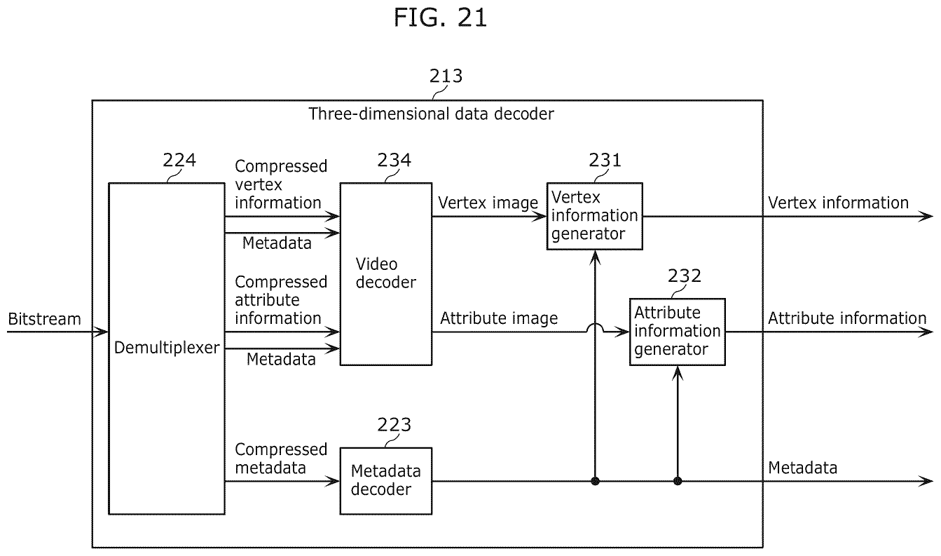

FIG. 21 is a block diagram illustrating another configuration example of three-dimensional data decoder 213 according to the present embodiment. In this example, three-dimensional data decoder 213 includes vertex information generator 231, attribute information generator 232, video decoder 234, metadata decoder 223, and demultiplexer 224. Vertex information generator 231, attribute information generator 232, and video decoder 234 may correspond to vertex information decoder 201, attribute information decoder 203, and the like illustrated in FIG. 8.

In addition, in this example, three-dimensional data decoder 213 decodes three-dimensional data according to a video-based encoding system. In decoding according to the video-based encoding system, a plurality of two-dimensional images are decoded according to a video encoding system and three-dimensional data is generated from the plurality of two-dimensional images. In this case, the video encoding system may be HEVC (high efficiency video coding), VVC (versatile video coding), or the like.

Specifically, first, a bitstream is input from a system layer into demultiplexer 224. Demultiplexer 224 separates compressed vertex information, metadata of the compressed vertex information, compressed attribute information, metadata of the compressed attribute information, and compressed metadata from the bitstream. The compressed vertex information, the metadata of the compressed vertex information, the compressed attribute information, and the metadata of the compressed attribute information are input to video decoder 234. The compressed metadata is input to metadata decoder 223.

Video decoder 234 decodes a vertex image according to the video encoding system. In doing so, video decoder 234 decodes the vertex image from the compressed vertex information using the metadata of the compressed vertex information. In addition, video decoder 234 inputs the vertex image into vertex information generator 231. Furthermore, video decoder 234 decodes an attribute image according to the video encoding system. In doing so, video decoder 234 decodes the attribute image from the compressed attribute information using the metadata of the compressed attribute information. In addition, video decoder 234 inputs the attribute image into attribute information generator 232.

Metadata decoder 223 decodes metadata from the compressed metadata. The metadata decoded by metadata decoder 223 includes map information to be used to generate vertex information and to generate attribute information. In addition, the metadata decoded by metadata decoder 223 may be used to decode the vertex image and to decode the attribute image.

Vertex information generator 231 reproduces vertex information from the vertex image according to the map information included in the metadata decoded by metadata decoder 223. Attribute information generator 232 reproduces attribute information from the attribute image according to the map information included in the metadata decoded by metadata decoder 223.

Subsequently, the vertex information, the attribute information, and the metadata are output from three-dimensional data decoder 213 as three-dimensional data. For example, the metadata is metadata of vertex information and attribute information and can be used in an application program.

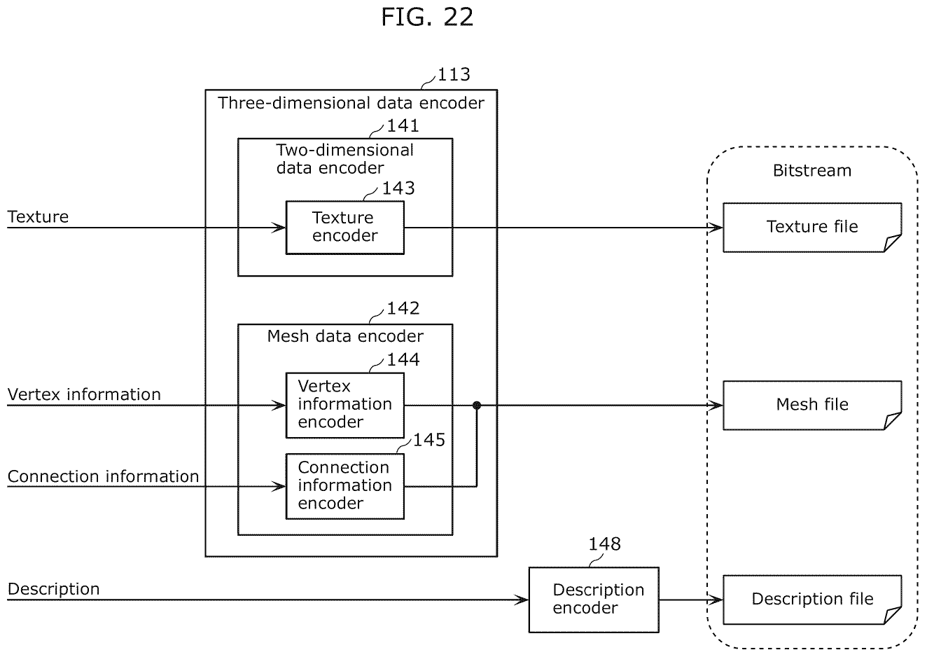

FIG. 22 is a conceptual diagram illustrating a specific example of encoding processing according to the present embodiment. FIG. 22 illustrates three-dimensional data encoder 113 and description encoder 148. In this example, three-dimensional data encoder 113 includes two-dimensional data encoder 141 and mesh data encoder 142. Two-dimensional data encoder 141 includes texture encoder 143. Mesh data encoder 142 includes vertex information encoder 144 and connection information encoder 145.

Vertex information encoder 144, connection information encoder 145, and texture encoder 143 may correspond to vertex information encoder 101, connection information encoder 102, attribute information encoder 103, and the like illustrated in FIG. 6.

For example, two-dimensional data encoder 141 operates as texture encoder 143 and generates a texture file by encoding a texture corresponding to attribute information as two-dimensional data according to an image encoding system or a video encoding system.

In addition, mesh data encoder 142 operates as vertex information encoder 144 and connection information encoder 145 and generates a mesh file by encoding vertex information and connection information. Mesh data encoder 142 may further encode mapping information with respect to a texture. The encoded mapping information may be included in a mesh file.

In addition, description encoder 148 generates a description file by encoding a description corresponding to metadata such as text data. Description encoder 148 may encode a description in the system layer. For example, description encoder 148 may be included in system multiplexer 114 illustrated in FIG. 12.

Due to the operation described above, a bitstream including a texture file, a mesh file, and a description file is generated. The files may be multiplexed in the bitstream in a file format such as gITF (graphics language transmission format) or USD (universal scene description).

Note that three-dimensional data encoder 113 may include two mesh data encoders as mesh data encoder 142. For example, one mesh data encoder encodes vertex information and connection information of a static three-dimensional mesh and the other mesh data encoder encodes vertex information and connection information of a dynamic three-dimensional mesh.

In addition, two mesh files may be included in the bitstream so as to correspond to the three-dimensional meshes. For example, one mesh file corresponds to the static three-dimensional mesh and the other mesh file corresponds to the dynamic three-dimensional mesh.

Furthermore, the static three-dimensional mesh may be an intra-frame three-dimensional mesh which is encoded using intra-prediction and the dynamic three-dimensional mesh may be an inter-frame three-dimensional mesh which is encoded using inter-prediction. In addition, as information of the dynamic three-dimensional mesh, difference information between vertex information or connection information of the intra-frame three-dimensional mesh and vertex information or connection information of the inter-frame three-dimensional mesh may be used.

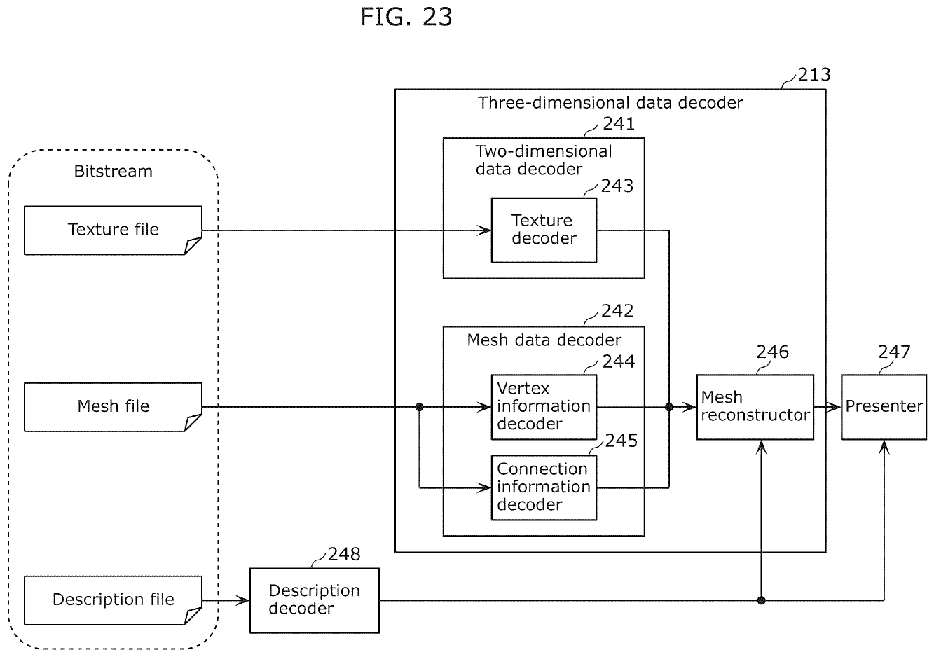

FIG. 23 is a conceptual diagram illustrating a specific example of decoding processing according to the present embodiment. FIG. 23 illustrates three-dimensional data decoder 213, description decoder 248, and presenter 247. In this example, three-dimensional data decoder 213 includes two-dimensional data decoder 241, mesh data decoder 242, and mesh reconstructor 246. Two-dimensional data decoder 241 includes texture decoder 243. Mesh data decoder 242 includes vertex information decoder 244 and connection information decoder 245.

Vertex information decoder 244, connection information decoder 245, texture decoder 243, and mesh reconstructor 246 may correspond to vertex information decoder 201, connection information decoder 202, attribute information decoder 203, postprocessor 205, and the like illustrated in FIG. 8. Presenter 247 may correspond to presenter 215 and the like illustrated in FIG. 12.

For example, two-dimensional data decoder 241 operates as texture decoder 243 and decodes a texture corresponding to attribute information from a texture file as two-dimensional data according to an image encoding system or a video encoding system.

In addition, mesh data decoder 242 operates as vertex information decoder 244 and connection information decoder 245 and decodes vertex information and connection information from a mesh file. Mesh data decoder 242 may further decode mapping information with respect to a texture from the mesh file.

Furthermore, description decoder 248 decodes a description corresponding to metadata such as text data from a description file. Description decoder 248 may decode a description in the system layer. For example, description decoder 248 may be included in system demultiplexer 214 illustrated in FIG. 12.

Mesh reconstructor 246 reconstructs a three-dimensional mesh from vertex information, connection information, and a texture according to a description. Presenter 247 renders and outputs the three-dimensional mesh according to the description.

Due to the operation described above, a three-dimensional mesh is reconstructed and output from a bitstream including a texture file, a mesh file, and a description file.

Note that three-dimensional data decoder 213 may include two mesh data decoders as mesh data decoder 242. For example, one mesh data decoder decodes vertex information and connection information of a static three-dimensional mesh and the other mesh data decoder decodes vertex information and connection information of a dynamic three-dimensional mesh.

In addition, two mesh files may be included in the bitstream so as to correspond to the three-dimensional meshes. For example, one mesh file corresponds to the static three-dimensional mesh and the other mesh file corresponds to the dynamic three-dimensional mesh.

Furthermore, the static three-dimensional mesh may be an intra-frame three-dimensional mesh which is encoded using intra-prediction and the dynamic three-dimensional mesh may be an inter-frame three-dimensional mesh which is encoded using inter-prediction. In addition, as information of the dynamic three-dimensional mesh, difference information between vertex information or connection information of the intra-frame three-dimensional mesh and vertex information or connection information of the inter-frame three-dimensional mesh may be used.

An encoding system of a dynamic three-dimensional mesh may be called DMC (dynamic mesh coding). In addition, a video-based encoding system of a dynamic three-dimensional mesh may be called VDMC (video-based dynamic mesh coding).

An encoding system of a point cloud may be called PCC (point cloud compression). A video-based encoding system of a point cloud may be called V-PCC (video-based point cloud compression). In addition, a geometry-based encoding system of a point cloud may be called G-PCC (geometry-based point cloud compression).

### Implementation Example

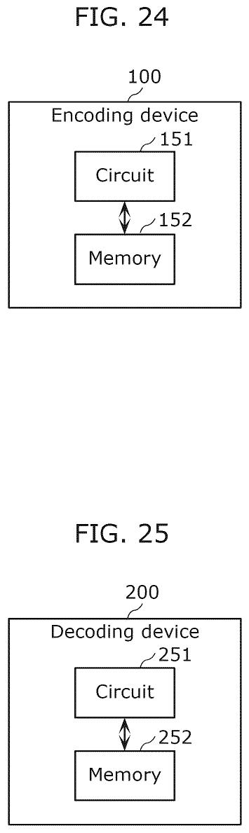

FIG. 24 is a block diagram illustrating an implementation example of encoding device 100 according to the present embodiment. Encoding device 100 includes circuit 151 and memory 152. For example, a plurality of constituent elements of encoding device 100 illustrated in FIG. 5 and the like are implemented by circuit 151 and memory 152 illustrated in FIG. 24.

Circuit 151 is a circuit which performs information processing and which is capable of accessing memory 152. For example, circuit 151 is a dedicated or general-purpose electric circuit which encodes a three-dimensional mesh. Circuit 151 may be a processor such as a CPU. Alternatively, circuit 151 may be a set of a plurality of electric circuits.

Memory 152 is a dedicated or general-purpose memory that stores information used by circuit 151 to encode a three-dimensional mesh. Memory 152 may be an electric circuit and may be connected to circuit 151. In addition, memory 152 may be included in circuit 151. Alternatively, memory 152 may be a set of a plurality of electric circuits. Furthermore, memory 152 may be a magnetic disk, an optical disk, or the like or may be expressed as a storage, a recording medium, or the like. In addition, memory 152 may be a non-volatile memory or a volatile memory.

For example, memory 152 may store a three-dimensional mesh or a bitstream. In addition, memory 152 may store a program used by circuit 151 to encode a three-dimensional mesh.

Note that in encoding device 100, all of the plurality of constituent elements illustrated in FIG. 5 and the like need not be implemented and all of the plurality of processing steps described herein need not be performed. A part of the plurality of constituent elements illustrated in FIG. 5 and the like may be included in another device and a part of the plurality of processing steps described herein may be executed by another device. In addition, a plurality of constituent elements according to the present disclosure may be optionally combined and implemented or a plurality of processing steps according to the present disclosure may be optionally combined and executed in encoding device 100.

FIG. 25 is a block diagram illustrating an implementation example of decoding device 200 according to the present embodiment. Decoding device 200 includes circuit 251 and memory 252. For example, a plurality of constituent elements of decoding device 200 illustrated in FIG. 7 and the like are implemented by circuit 251 and memory 252 illustrated in FIG. 25.

Circuit 251 is a circuit which performs information processing and which is capable of accessing memory 252. For example, circuit 251 is a dedicated or general-purpose electric circuit which decodes a three-dimensional mesh. Circuit 251 may be a processor such as a CPU. Alternatively, circuit 251 may be a set of a plurality of electric circuits.

Memory 252 is a dedicated or general-purpose memory that stores information used by circuit 251 to decode a three-dimensional mesh. Memory 252 may be an electric circuit and may be connected to circuit 251. In addition, memory 252 may be included in circuit 251. Alternatively, memory 252 may be a set of a plurality of electric circuits. Furthermore, memory 252 may be a magnetic disk, an optical disk, or the like or may be expressed as a storage, a recording medium, or the like. In addition, memory 252 may be a non-volatile memory or a volatile memory.

For example, memory 252 may store a three-dimensional mesh or a bitstream. In addition, memory 252 may store a program used by circuit 251 to decode a three-dimensional mesh.

Note that in decoding device 200, all of the plurality of constituent elements illustrated in FIG. 7 and the like need not be implemented and all of the plurality of processing steps described herein need not be performed. A part of the plurality of constituent elements illustrated in FIG. 7 and the like may be included in another device and a part of the plurality of processing steps described herein may be executed by another device. In addition, a plurality of constituent elements according to the present disclosure may be optionally combined and implemented or a plurality of processing steps according to the present disclosure may be optionally combined and executed in decoding device 200.

An encoding method and a decoding method including steps performed by each constituent element of encoding device 100 and decoding device 200 according to the present disclosure may be executed by any device or system. For example, a part of or all of the encoding method and the decoding method may be executed by a computer including a processor, a memory, an input/output circuit, and the like. In doing so, the encoding method and the decoding method may be executed by having the computer execute a program that enables the computer to execute the encoding method and the decoding method.

In addition, a program or a bitstream may be recorded on a non-transitory computer-readable recording medium such as a CD-ROM.

An example of a program may be a bitstream. For example, a bitstream including an encoded three-dimensional mesh includes a syntax element that enables decoding device 200 to decode the three-dimensional mesh. In addition, the bitstream causes decoding device 200 to decode the three-dimensional mesh according to the syntax element included in the bitstream. Therefore, a bitstream can perform a similar role to a program.

The bitstream described above may be an encoded bitstream including an encoded three-dimensional mesh or a multiplexed bitstream including an encoded three-dimensional mesh and other information.

In addition, each constituent element of encoding device 100 and decoding device 200 may be constituted of dedicated hardware, general-purpose hardware which executes the program or the like described above, or a combination thereof. Furthermore, the general-purpose hardware may be constituted of a memory on which a program is recorded, a general-purpose processor which reads the program from the memory and executes the program, and the like. In this case, the memory may be a semiconductor memory, a hard disk, or the like and the general-purpose processor may be a CPU or the like.

Furthermore, the dedicated hardware may be constituted of a memory, a dedicated processor, and the like. For example, the dedicated processor may execute the encoding method and the decoding method by referring to a memory for recording data.

In addition, as described above, the respective constituent elements of encoding device 100 and decoding device 200 may be electric circuits. The electric circuits may constitute one electric circuit as a whole or may be respectively different electric circuits. Furthermore, the electric circuits may correspond to dedicated hardware or to general-purpose hardware which executes the program or the like described above. Moreover, encoding device 100 and decoding device 200 may be implemented as integrated circuits.

In addition, encoding device 100 may be a transmitting device which transmits a three-dimensional mesh. Decoding device 200 may be a receiving device which receives a three-dimensional mesh.

### <Inter Prediction and Intra Prediction>

In general, a three-dimensional model represents an object digitally such that a user can explore a model using zooming, panning, and/or rotation in all three dimensions while rendering it temporally. One way to construct such a representation is to construct a 3D mesh using triangles. The three-dimensional model stores the positions of the vertices of the triangles, connectivity of the vertices of the triangles with each other, and the attributes associated therewith (such as a normal, UV patches, etc.). Storing all of these types of information in an uncompressed form needs very large storage space. Therefore, a very large bandwidth for transmission of these items of information. The triangles forming the three-dimensional mesh often have a repetitive pattern and similar attributes especially in the temporal and spatial neighborhood. The repetition can be used to formulate an efficient encoding and decoding method for storage and transmission.

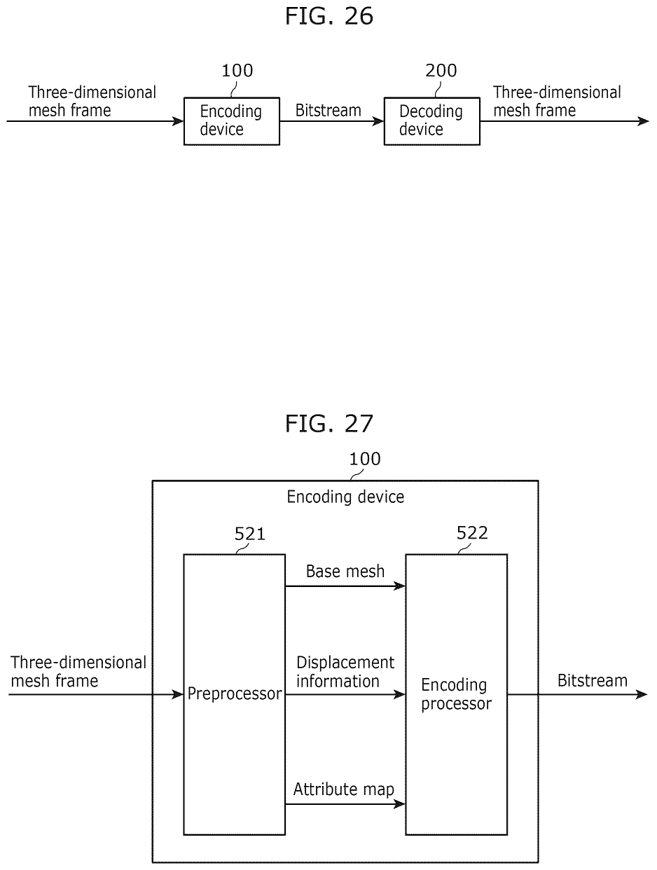

FIG. 26 is a block diagram illustrating a configuration example of the encoding/decoding system according to the present embodiment.

The encoding/decoding system includes encoding device 100 and decoding device 200. The encoding/decoding system receives a three-dimensional mesh that is input in the form of three-dimensional coordinates, connection information (connectivity), and associated attributes of vertices. Encoding device 100 is responsible for encoding all related information into a bitstream (compressed bitstream). The bitstream may be formed by a plurality of bitstreams. The bitstream is transmitted to decoding device 200 via a transmission path. Decoding device 200 decodes the bitstream to produce a three-dimensional model (three-dimensional mesh frame) using the decoded vertices' three-dimensional coordinates, connection information, and associated attributes.

FIG. 27 is a block diagram illustrating another configuration example of encoding device 100 according to the present embodiment.

In this example, encoding device 100 includes preprocessor 521 and encoding processor 522.

Preprocessor 521 reads an input three-dimensional mesh frame, processes the three-dimensional mesh frame to extract a base mesh, displacement information, and an attribute map, and output the base mesh, displacement information, and the attribute map to encoding processor 522. One example of the displacement information is displacement vectors.

Encoding processor 522 individually compresses the base mesh, the displacement information, and the attribute map and couples them to produce a bitstream.

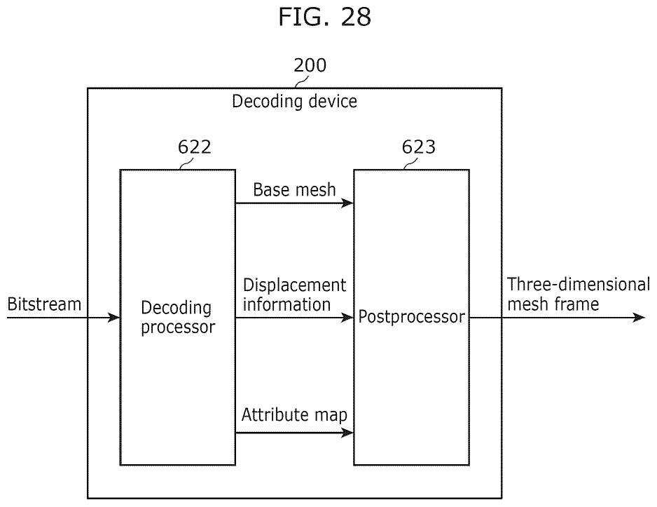

FIG. 28 is a block diagram illustrating another configuration example of decoding device 200 according to the present embodiment.

In this example, decoding device 200 includes decoding processor 622 and postprocessor 623.

Decoding processor 622 reads a bitstream, separates an encoded base mesh, encoded displacement information, and an encoded attribute map from the read bitstream, and individually decodes and outputs them to postprocessor 623. One example of the displacement information is displacement vectors.

Postprocessor 623 processes the base mesh using the displacement information and the attribute map to produce a three-dimensional mesh frame. The produced three-dimensional mesh frame is output to a display and displayed on the display, for example. By repeating such processing, three-dimensional mesh frames are repeatedly displayed on the display.

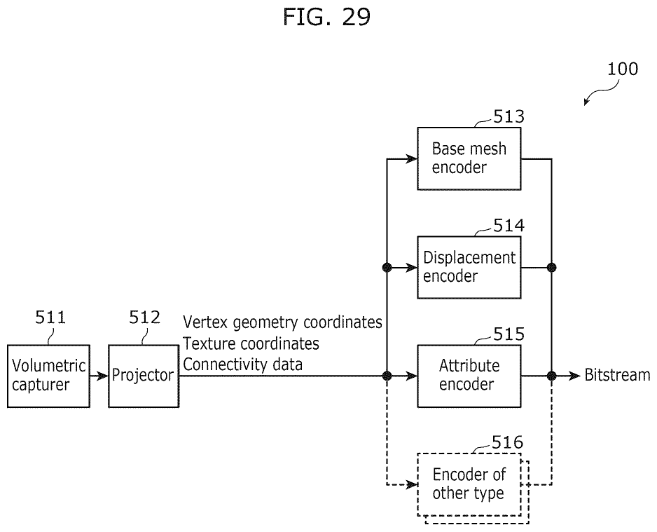

FIG. 29 is a block diagram illustrating yet another configuration example of encoding device 100 according to the present embodiment.

In this example, encoding device 100 includes volumetric capturer 511, projector 512, base mesh encoder 513, displacement encoder 514, and attributer encoder 515, and optionally includes one or more encoders 516 of other types.

Volumetric capturer 511 captures a content and outputs the captured content to projector 512.

Projector 512 projects the content onto a three-dimensional mesh frame that includes vertex geometry coordinates (vertex coordinates indicating the position of a vertex), texture coordinates, and connectivity data (connection information). The data is output to base mesh encoder 513, displacement encoder 514, and attributer encoder 515, and optionally to one or more encoders 516 of other types. Each encoder compresses the data into a bitstream.

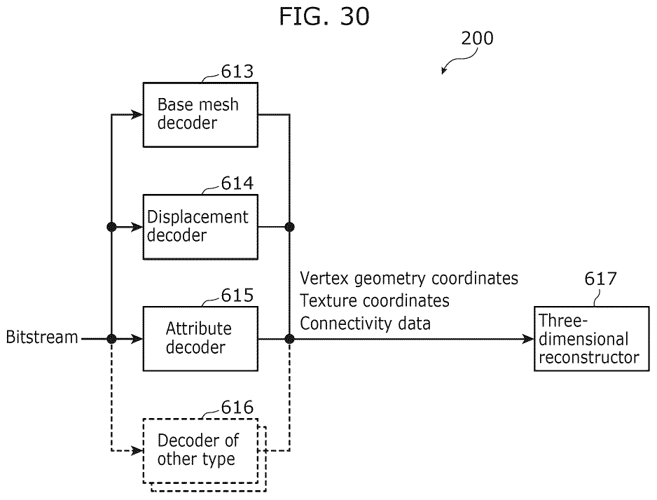

FIG. 30 is a block diagram illustrating yet another configuration example of decoding device 200 according to the present embodiment.

In this example, decoding device 200 includes base mesh decoder 613, displacement decoder 614, attribute decoder 615, one or more decoders 616 of other types, and three-dimensional reconstructor 617.

A bitstream is sent to base mesh decoder 613, displacement decoder 614, and attribute decoder 615 and optionally to one or more decoders 616 of other types. These decoders decode the bitstream to produce decoded data including vertex geometry coordinates, texture coordinates, and connectivity data. The decoded data is then sent to three-dimensional reconstructor 617, where a three-dimensional mesh frame is reconstructed.

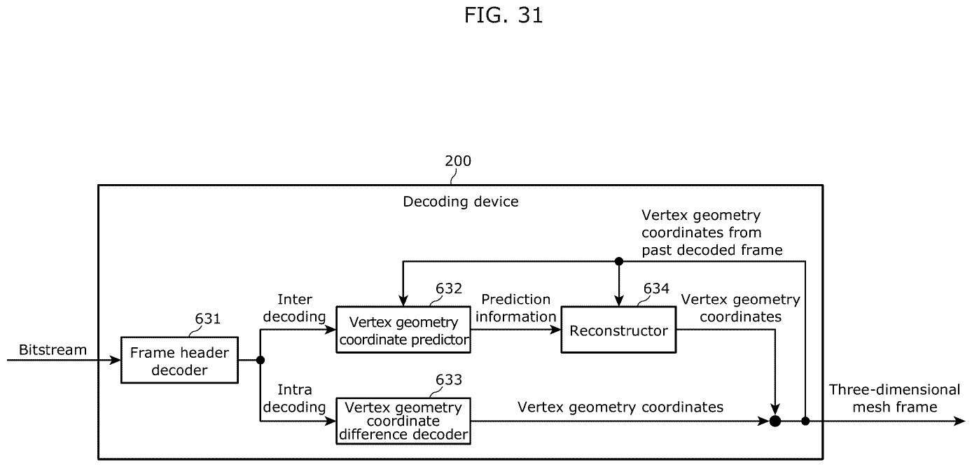

FIG. 31 is a block diagram illustrating a detailed configuration example of decoding device 200 according to the present embodiment. Specifically, FIG. 31 illustrates an example of the configuration of a geometry coordinate decoder included in decoding device 200.

In this example, decoding device 200 includes frame header decoder 631, vertex geometry coordinate predictor 632, vertex geometry coordinate difference decoder 633, and reconstructor 634.

Frame header decoder 631 reads a bitstream, decodes a frame header in the bitstream, and determines whether to intra-decode (intra-predict) or inter-decode (inter-predict) frame data.

When the inter-decoding is selected, the frame data included in the bitstream is output to vertex geometry coordinate predictor 632.

Vertex geometry coordinate predictor 632 outputs prediction information to reconstructor 634. One example of the prediction information is motion vectors.

Reconstructor 634 outputs three-dimensional coordinates of a vertex (vertex geometry coordinates) using vertex coordinates from a frame decoded in the past and the prediction information.

On the other hand, when the intra-decoding is selected, the frame data included in the bitstream is output to vertex geometry coordinate difference decoder 633.

In order to produce vertex coordinates, vertex geometry coordinate difference decoder 633 decodes the frame data encoded as a difference between coordinates of vertices included in the frame. Only one of the vertex geometry coordinates from vertex geometry coordinate difference decoder 633 and the vertex geometry coordinates from reconstructor 634 is used for producing the decoded three-dimensional mesh frame.

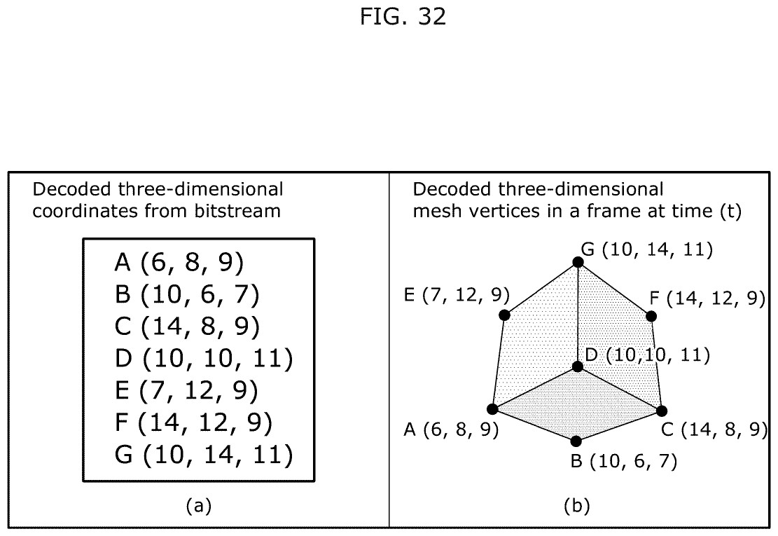

FIG. 32 is a diagram for describing coordinates of vertices in a three-dimensional mesh according to the present embodiment. Specifically, FIG. 32 illustrates an example in which the whole of a three-dimensional mesh frame is decoded using coordinates (positions) of actual vertices included in the bitstream.

The coordinates of vertex A included in the three-dimensional mesh frame at a time (t) are decoded to be (6, 8, 9) in the Cartesian coordinate system (x, y, z) as illustrated in (a) in FIG. 32. Similarly, the coordinates of vertex B are decoded to be (10, 6, 7), and the coordinates of vertex C are decoded to be (14, 8, 9). Vertices D to G are also decoded in the same manner.

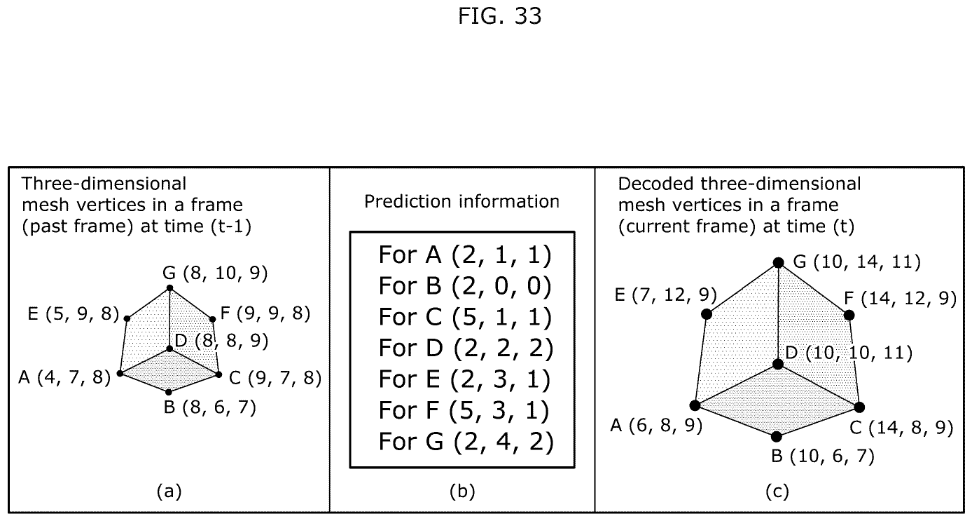

FIG. 33 is a diagram for describing prediction information according to the present embodiment. Specifically, FIG. 33 illustrates another example in which the whole of a three-dimensional mesh frame at a time (t) is decoded using a frame at a time (t−1) (past frame) and prediction information included in the bitstream.

Coordinates (6, 8, 9) of vertex A in the frame to be decoded (present frame) are decoded by summing coordinates (4, 7, 8) of vertex A in the past frame and values (2, 1, 1) relating to vertex A indicated by the prediction information. Similarly, coordinates (10, 6, 7) of vertex B in the present frame are decoded by summing coordinates (8, 6, 7) of vertex B in the past frame and values (2, 0, 0) relating to vertex B indicated by the prediction information.

As one method of encoding a three-dimensional mesh frame, it can be contemplated to divide an original three-dimensional mesh (original mesh) into smaller meshes (submeshes) and encode each submesh independently. The vertices in the three-dimensional mesh frame are divided such that information indicating coordinates of vertices in each partition and connection information on the vertices can be independently encoded. Each smaller mesh resulting from the division is referred to as a submesh.

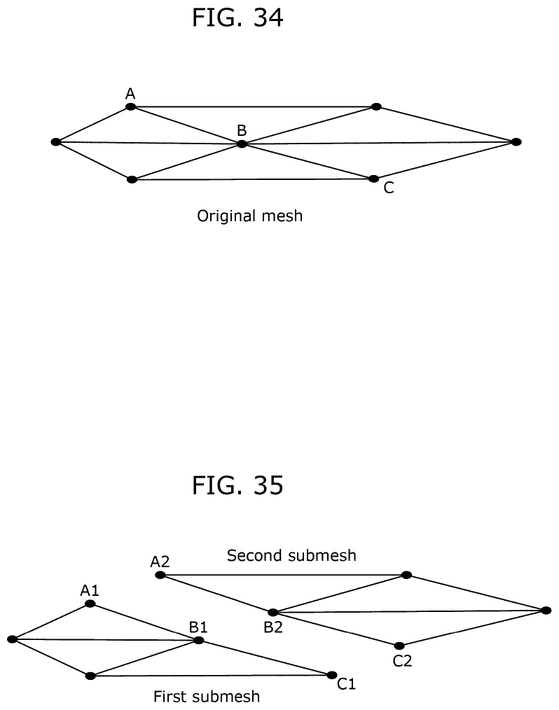

FIG. 34 is a diagram for describing an example of a mesh (original mesh) according to the present embodiment. FIG. 35 is a diagram for describing an example of division of the mesh into submeshes according to the present embodiment. Specifically, FIG. 35 is a diagram illustrating division of the mesh illustrated in FIG. 34 into two submeshes.

Here, vertices A, B, and C of the original mesh are duplicated to form vertices A1, B1, and C1 and vertices A2, B2, and C2, thereby creating (producing) two submeshes (first submesh and second submesh) each of which can be independently encoded and decoded. The first submesh and the second submesh are meshes that can be independently decoded.

As described above, the mesh can be divided into a plurality of parts smaller than the mesh and can be encoded on a division basis. In the division of the mesh, the vertices of the mesh are divided such that the coordinates of vertices included in each division and the connection information on the vertices can be independently encoded.

Note that the mesh illustrated in FIG. 34 is an original mesh and may be referred to as a full mesh in contrast with the submesh.

### <Calculation of Adjacent Points>

Next, an encoding method and a decoding method for the prediction information output from vertex geometry coordinate predictor 632 illustrated in FIG. 31 will be described in detail.

Note that the following description will be made using an example in which the prediction information is a motion vector of a vertex (in other words, a three-dimensional point) included in the base mesh.

Note that the prediction information is not necessarily limited to motion vectors and may be other information of three-dimensional points. For example, the prediction information may be position information (geometry) or attribute information (attribute) of three-dimensional points.

Here, the position information includes coordinates (x coordinate, y coordinate, z coordinate) with respect to a point, for example. The attribute information includes color information (such as RGB or YUV), a reflectance, a normal vector, and the like of each three-dimensional point, for example. Note that the attribute information may be information represented by a vector.

Furthermore, when the prediction information output by vertex geometry coordinate predictor 632 is a motion vector, vertex geometry coordinate predictor 632 may be referred to as a motion decoder.

Note that the following description will be made using an integer value as a motion vector (to be specific, a value of a motion vector). For example, when the motion vector is in 8-bit precision, the motion vector assumes an integer value from 0 to 255. When the value of the motion vector is in 10-bit precision, the motion vector assumes an integer value from 0 to 1023.

Note that when the bit precision of the motion vector is a decimal precision, the decimal fraction may be multiplied by a scale value and then rounded to an integer value.

Note that the scale value may be added to the bitstream, such as the header.

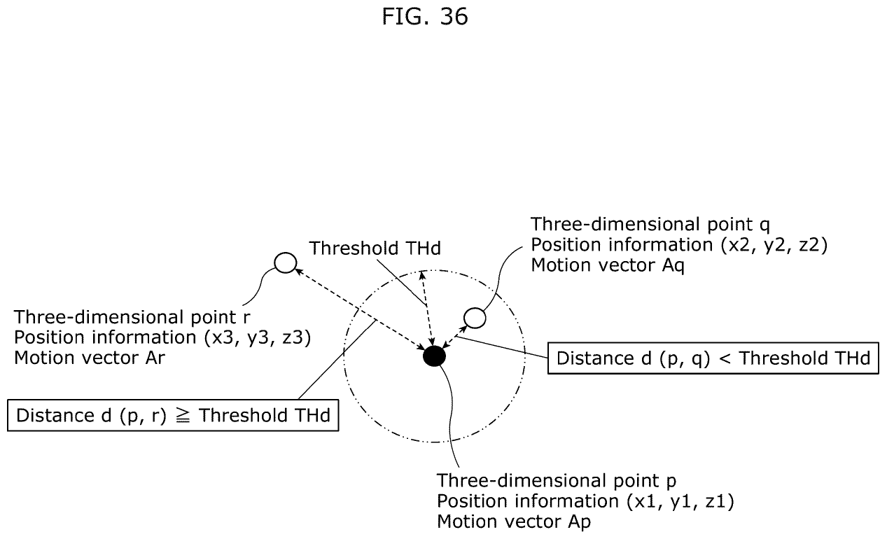

FIG. 36 is a diagram for describing a positional relationship between three-dimensional points according to the present embodiment.

As an encoding method for a motion vector of a three-dimensional point, it can be contemplated to calculate a prediction value of a motion vector of a three-dimensional point and encode the difference (prediction residual) between the original value of the motion vector and the prediction value. For example, when the value of a motion vector of three-dimensional point p is Ap, and the prediction value is Pp, encoding device 100 encodes absolute difference value Diffp=|Ap−Pp| that indicates the absolute value of the difference therebetween. In this case, if prediction value Pp can be produced with high precision, the value of absolute difference value Diffp decreases. Therefore, for example, if encoding device 100 performs entropy encoding using an encoding table in which the number of bits produced decreases as the value becomes smaller, the code amount can be reduced.

As a method in which encoding device 100 produces a prediction value of a motion vector, it can be contemplated to use a motion vector of another three-dimensional point around the three-dimensional point to be encoded. Here, the “three-dimensional point around the three-dimensional point” refers to another three-dimensional point within a predetermined distance (within a predetermined range) from the three-dimensional point. For example, provided that there are three-dimensional point p=(x1, y1, z1), which is a three-dimensional point to be encoded, and three-dimensional point q=(x2, y2, z2), when Euclidean distance d (p, q)=√((x1−x2)²+(y1−y2)²+(z1−z2)²) between three-dimensional point p and three-dimensional point q is smaller than threshold THd, encoding device 100 determines that the position of three-dimensional point q is close to the position of three-dimensional point p and determines to use the value of the motion vector of three-dimensional point q for production of the prediction value of the motion vector of three-dimensional point p.

Note that the distance calculation method may be another method, and the Mahalanobis distance or the like may be used.

Furthermore, the predetermined distance can be arbitrarily determined and is not particularly limited.

Furthermore, for example, encoding device 100 may determine not to use a three-dimensional point at a distance greater than the predetermined distance from the three-dimensional point to be encoded (outside of the predetermined range) for prediction. When there is three-dimensional point r, and distance d(p, r) between three-dimensional point p and three-dimensional point r is equal to or greater than threshold THd, for example, encoding device 100 may determine not to use three-dimensional point r for prediction.

Note that encoding device 100 may add the value of threshold THd to the header of the bitstream.

When encoding the motion vector of the three-dimensional point to be encoded using a prediction value, if a motion vector of a three-dimensional point around the three-dimensional point used for production of the prediction value is used, for example, encoding device 100 uses an already encoded motion vector or an already decoded motion vector.

Furthermore, when decoding the motion vector of the three-dimensional point to be decoded using a prediction value, if a motion vector of a three-dimensional point around the three-dimensional point used for production of the prediction value is used, decoding device 200 uses an already decoded motion vector.

In this way, the same prediction value is produced in encoding and decoding. Therefore, decoding device 200 can correctly decode the bitstream of three-dimensional points produced by encoding device 100.

Note that although the “point around the three-dimensional point” has been described as referring to another three-dimensional point in a predetermined range from the three-dimensional point, this is not intended to be limiting. For example, in the case of three-dimensional point D (that is, vertex D) illustrated in FIG. 33, there are three-dimensional points A, three-dimensional point B, three-dimensional point C, three-dimensional point E, three-dimensional point F, and three-dimensional point G as three-dimensional points around the three-dimensional point, and a three-dimensional point around the three-dimensional point (in other words, an adjacent point) may be selected under one or more of the conditions A and B described below. That is, the adjacent point is a point selected under a condition and is referenced for predicting information of the three-dimensional point to be encoded. The adjacent point may be referred to also as a reference three-dimensional point, a reference point, or a reference vertex, for example.

Condition A: a three-dimensional point having connectivity with the current three-dimensional point.

Condition B: a three-dimensional point encoded or decoded before the current three-dimensional point.

For example, in the case of selecting a three-dimensional point that meets the conditions A and B described above as an adjacent point, when the three-dimensional points are encoded or decoded in the order of three-dimensional points A, B, C, D, E, F, and G, three-dimensional points A and C may be selected as adjacent points of three-dimensional point D. Since three-dimensional points A and C have connectivity with three-dimensional point D, the values of the motion vectors thereof are likely to be close to each other. Furthermore, since three-dimensional points A and C are encoded or decoded before three-dimensional point D, the motion vectors of three-dimensional points A and C can be used for calculation of the prediction value of the motion vector of three-dimensional point D.

In this way, the precision of the prediction value of the motion vector of three-dimensional point D can be improved, and the encoding efficiency can be improved.

Note that as a condition for selecting adjacent points of a three-dimensional point, the number of adjacent points may be limited to be equal to or smaller than a predetermined value (NumNeiCnt), in addition to the conditions A and B described above. For example, by setting NumNeiCnt=3, the number of adjacent points of a three-dimensional point may be limited to 3 or less.

In this way, the memory space for storing the information of the adjacent points of the three-dimensional point can be reduced, and the processing amount for predicting (calculating) the motion vector can be reduced.

Note that the predetermined value can be arbitrarily determined and is not particularly limited.

Furthermore, for example, encoding device 100 may add the predetermined value described above, or in other words, NumNeiCnt indicating the maximum value of the number of adjacent points, to the bitstream by adding the predetermined value to the header of the data unit before encoding, for example.

In this way, decoding device 200 can properly decode the bitstream with the maximum number of adjacent points limited to NumNeiCnt or less by decoding the header of the bitstream.

Note that when there are a larger number of three-dimensional points that meet the conditions A and B described above than NumNeiCnt as adjacent points, adjacent points may be selected in ascending order of the distance from the three-dimensional point to be encoded or decoded. For example, in the case where NumNeiCnt=3, as adjacent points of three-dimensional point D, if there are five three-dimensional points A, C, H, I, and J that meet the conditions A and B described above, and the ascending order of the distance from three-dimensional point D is A>C>H>I>J, three-dimensional points A, C, and H may be selected as adjacent points of three-dimensional point D. Three-dimensional points A, C, and H have connectivity with three-dimensional point D and are close to three-dimensional point D, so that the values of the motion vectors thereof are likely to be close to the value of the motion vector of three-dimensional point D. In addition, three-dimensional points A, C, and H are encoded or decoded before three-dimensional point D. Therefore, the motion vectors of three-dimensional points A, C, and H can be used for calculation of the prediction value of the motion vector of three-dimensional point D.

In this way, the precision of the prediction value of the motion vector of three-dimensional point D can be improved. In addition, since the number of adjacent points is limited, the memory space for storing information on the adjacent points of the three-dimensional point can be reduced, and the processing amount for calculating (predicting) the motion vector can be reduced.

Note that when the connectivity with the three-dimensional point to be encoded or decoded (referred to also as a current three-dimensional point, hereinafter) is used as the condition A for selecting adjacent points of the current three-dimensional point, the connectivity that can be used is not limited to the connectivity in the frame to be encoded or decoded (referred to also as a current frame, hereinafter). For example, connectivity in an already encoded or decoded frame may be used. For example, in the case of the example illustrated in FIG. 33, when adjacent points of each three-dimensional point (each current three-dimensional point) in the frame (present frame) at time (t) are selected under the condition A described above, the connectivity of each corresponding three-dimensional point in the frame (past frame) at time (t−1) may be used. More specifically, when selecting adjacent points of three-dimensional point D in the present frame under the condition A described above, encoding device 100 or decoding device 200 may reference to the connectivity of three-dimensional point D in the past frame to select three-dimensional points A, C, and G, and select, from among them, already encoded or decoded three-dimensional points A and C as adjacent points. For the frame encoded or decoded before the current frame, such as the past frame, encoding device 100 and decoding device 200 can calculate the connectivity and distance between three-dimensional points and therefore can properly calculate adjacent points of the current three-dimensional point using the condition A described above or the distance (distance information) between the three-dimensional points.

Note that although an example in which a past frame is used as a frame preceding the current frame is illustrated in the present embodiment, this is not intended to be limiting, and any already encoded or decoded frame can be used.

Accordingly, encoding device 100 and decoding device 200 can properly calculate adjacent points of the current three-dimensional point using the connectivity and/or distance.

Note that that the present embodiment may be applied to a case where the correspondence between three-dimensional points in the current frame and three-dimensional points in the already encoded or decoded frame is known. For example, in the case of the example illustrated in FIG. 33, the correspondence between the present frame and the past frame is known for three-dimensional points A, B, C, D, E, F, and G, so that adjacent points of the three-dimensional point in the present frame can be calculated using the connectivity and/or distance in the past frame as illustrated in the present embodiment.

Note that when the correspondence between three-dimensional points in the current frame and three-dimensional points in the already encoded or decoded frame is not known, encoding device 100 and decoding device 200 may calculate (select) an adjacent point using the connectivity of three-dimensional points in the current frame without using the distance.

In this way, even when the correspondence with three-dimensional points in the encoded or decoded frame is not known, adjacent points can be calculated.

Note that encoding device 100 may add, to the bitstream, information indicating whether the correspondence between three-dimensional points in the frame to be encoded and three-dimensional points in an already encoded or decoded frame is known.

In this way, decoding device 200 can know whether the correspondence between three-dimensional points in the frame to be encoded (the frame that is encoded by encoding device 100 and is to be decoded by decoding device 200) and three-dimensional points in already decoded the frame is known. For example, decoding device 200 can switch the calculation method for adjacent points in such a manner that decoding device 200 calculates adjacent points of the three-dimensional point in the frame to be decoded using the connectivity and/or distance in the decoded frame when the correspondence between three-dimensional points is known, and calculates adjacent points using the connectivity of three-dimensional points in the frame to be decoded without using the distance when the correspondence between three-dimensional points is not known.

Note that, in decoding, when the distances between the three-dimensional point to be decoded and adjacent points in the frame to be decoded cannot be calculated before decoding the position information of the three-dimensional point to be decoded, decoding device 200 may calculate adjacent points of the three-dimensional point to be decoded using the distances between the three-dimensional point corresponding to the three-dimensional point to be decoded and adjacent points in the already decoded frame.

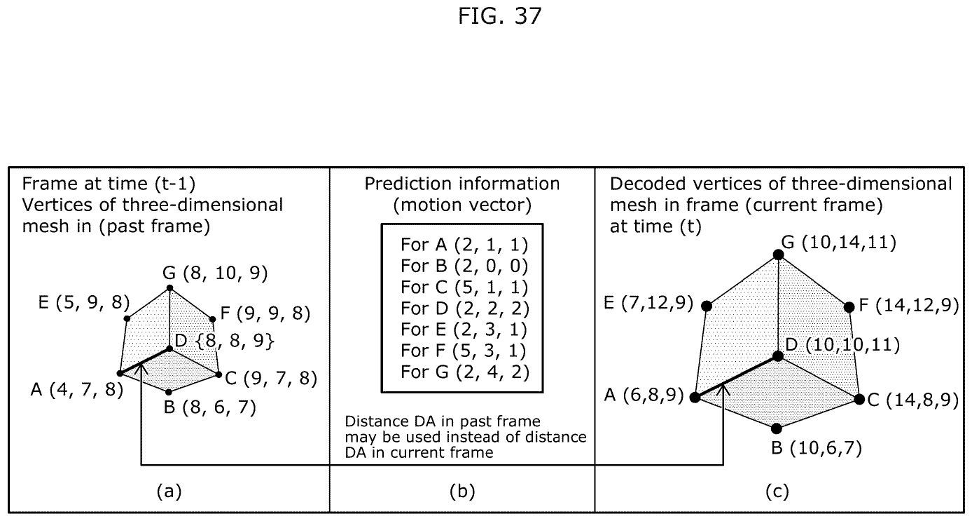

FIG. 37 is a diagram for describing distances between three-dimensional points according to the present embodiment.

For example, in the case of the example illustrated in FIG. 37, as the distance between each three-dimensional point and an adjacent point thereof in the present frame at time (t), the distance between the correspondence three-dimensional point and the corresponding adjacent point in the past frame at time (t−1) may be used. More specifically, as the distances between three-dimensional point D and adjacent points A, C, and G in the present frame, the distances between three-dimensional point D and adjacent points A, C, and G in the past frame may be used. For the frame decoded before the frame to be decoded, such as the past frame, decoding device 200 can calculate the distances between the three-dimensional points with reliability and therefore can properly calculate adjacent points of the three-dimensional point to be decoded using the distances.

Note that although an example in which a past frame is used as a frame preceding the frame to be decoded is illustrated in the present embodiment, this is not intended to be limiting, and any already decoded frame can be used.

In this way, decoding device 200 can properly calculate adjacent points close to the three-dimensional point to be decoded and therefore can calculate (predict) the three-dimensional motion vector to be decoded with high precision. This improves the encoding efficiency.

Note that when decoding device 200 calculates, in decoding, adjacent points of the three-dimensional point to be decoded using the distances between the three-dimensional point corresponding to the three-dimensional point to be decoded and adjacent points in an already decoded frame, encoding device 100 may, in conformity with decoding device 200 in encoding, calculate adjacent points of the three-dimensional point to be encoded using the distances between the three-dimensional point corresponding to the three-dimensional point to be encoded and adjacent points in an already encoded frame.

In this way, the same calculation method for adjacent points can be used in encoding and decoding, and decoding device 200 can properly decode the bitstream produced by encoding.

Note that the same holds true for the connectivity, and encoding device 100 and decoding device 200 may calculate the connectivity of the current three-dimensional point using the connectivity between the three-dimensional point corresponding to the current three-dimensional point and adjacent points in the already encoded or decoded frame.

In this way, the connectivity and the distance can be calculated at the same time using information of the already encoded or decoded frame, so that the processing amount can be reduced.

Note that encoding device 100 and decoding device 200 may select an appropriate adjacent point using the connectivity in the current frame and the distances between the three-dimensional point corresponding to the current three-dimensional point and adjacent points in the already encoded or decoded frame.

In this way, encoding device 100 and decoding device 200 can calculate an adjacent point that has connectivity with the current three-dimensional point and is close to the current three-dimensional point in the current frame using information of the already encoded or decoded frame. Therefore, the motion vector of the current three-dimensional point is calculated (predicted) with high precision, and the encoding efficiency is improved.

Note that when adjacent points are calculated without using the distance, adjacent points may be calculated using connectivity in the current frame. In this way, the processing amount can be reduced.

Furthermore, when the distance is not used, and the number of adjacent points is limited by NumNeiCnt, encoding device 100 and decoding device 200 may stop calculating adjacent points when the number of adjacent points reaches NumNeiCnt when increasing the adjacent points of the current three-dimensional point. In this way, the processing amount can be reduced.

Furthermore, when the number of adjacent points reaches NumNeiCnt when increasing the adjacent points of the current three-dimensional point, encoding device 100 and decoding device 200 may replace at least one adjacent point of the adjacent points already stored as adjacent points with a newly found adjacent point in the subsequent process. In this way, the encoding efficiency can be improved while limiting the number of adjacent points.

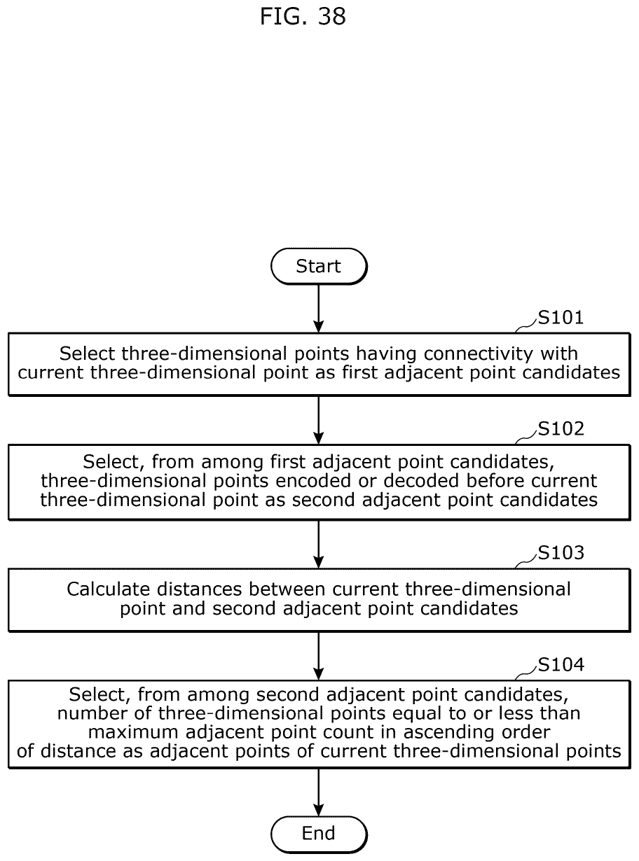

FIG. 38 is a flowchart illustrating a selection process for adjacent points according to the present embodiment. Note that the flow illustrated in FIG. 38 is a specific example of the procedure performed by each of encoding device 100 and decoding device 200 when calculating adjacent points of a current three-dimensional point.

First, encoding device 100 and decoding device 200 select, from among a plurality of three-dimensional points included in the current frame, three-dimensional points having connectivity with the current three-dimensional point as first adjacent point candidates (S101).

Encoding device 100 and decoding device 200 then select, from among the plurality of first adjacent point candidates selected in step S101, three-dimensional points encoded or decoded before the current three-dimensional point as second adjacent point candidates (S102). For example, encoding device 100 selects, from among the plurality of first adjacent point candidates, three-dimensional points encoded before the current three-dimensional point as second adjacent point candidates. Furthermore, for example, decoding device 200 selects, from among the plurality of first adjacent point candidates, three-dimensional points decoded before the current three-dimensional point as second adjacent point candidates.

Encoding device 100 and decoding device 200 then calculate the distance between the current three-dimensional point and each of the plurality of second adjacent point candidates selected in step S102 (S103).

Encoding device 100 and decoding device 200 then select, from among the plurality of second adjacent point candidates selected in step S102, a number of three-dimensional points equal to or less than the maximum adjacent point count (NumNeiCnt described above) in ascending order of the distance, to thereby select the adjacent points of the current three-dimensional point (S104).

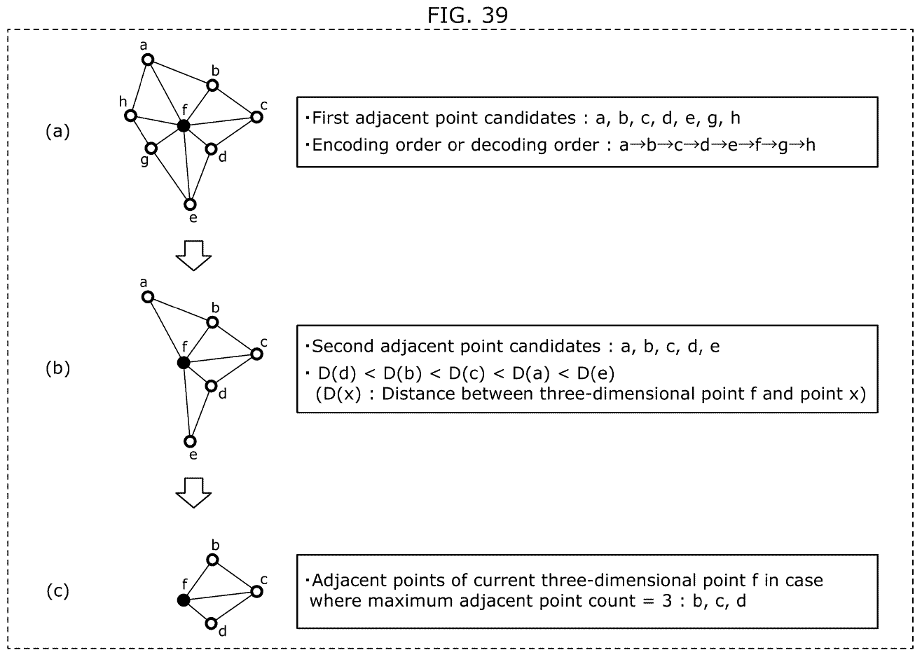

FIG. 39 is a diagram for describing a selection process for adjacent points according to the present embodiment. Note that in the example illustrated in FIG. 39, the current three-dimensional point is three-dimensional point f. Furthermore, in the example illustrated in FIG. 39, three-dimensional points a, b, c, d, e, f, g, and h are encoded or decoded in this order. That is, in the example illustrated in FIG. 39, three-dimensional points a, b, c, d, and e are encoded or decoded three-dimensional points. Furthermore, in the example illustrated in FIG. 39, three-dimensional points having connectivity are linked by a solid line. Furthermore, in the example illustrated in FIG. 39, the distance between three-dimensional points f and x (x denotes a, b, c, d, e, g, or h) is denoted as D(x), and three-dimensional points d, b, c, a, and e are close to three-dimensional point f in this order. Furthermore, in the example illustrated in FIG. 39, the maximum adjacent point count (NumNeiCnt described above) is 3.

For example, in step S101, encoding device 100 and decoding device 200 select three-dimensional points a, b, c, d, e, g, and h as first adjacent point candidates, as illustrated in (a) in FIG. 39.

Furthermore, for example, in step S102, encoding device 100 and decoding device 200 select three-dimensional points a, b, c, d, and e as second adjacent point candidates, as illustrated in (b) in FIG. 39.

Furthermore, for example, in step S104, encoding device 100 and decoding device 200 select three-dimensional points b, c, and d as first adjacent points, as illustrated in (c) in FIG. 39.

Note that the flowchart illustrated in FIG. 38 is just an example, and the order in which steps S101 to S104 are performed can be arbitrarily changed. For example, when step S101 and step S102 are interchanged, encoding device 100 and decoding device 200 may select three-dimensional points encoded or decoded before the current three-dimensional point as first adjacent point candidates in the processing in step S102, and then select, from among the first adjacent point candidates, three-dimensional points having connectivity with the current three-dimensional point as second adjacent point candidates in the processing in step S101. In this way, the flexibility of the implementation can be improved.

Furthermore, for example, in the process from step S101 to step S104, some processing may be performed in parallel. For example, if the processing in step S103 is performed while the processing in step S102 is performed, the distance between the current three-dimensional point and each of the second adjacent point candidates can be calculated earlier in parallel with the selection processing. In this way, the processing time can be reduced.

Note that a motion group (motion group/MG) may be provided as a prediction unit according to the encoding order or the decoding order. When encoding or decoding the motion vectors of three-dimensional points, encoding device 100 and decoding device 200 may encode or decode the motion vectors on a MG basis. For example, the number (MGSize) of three-dimensional points included in one MG may be prescribed, and encoding device 100 and decoding device 200 may encode or decode the three-dimensional points by dividing the three-dimensional points into a plurality of MGs in accordance with the encoding order or the decoding order.

Note that the encoding order and the decoding order of the motion vectors of three-dimensional points can be any order. For example, encoding device 100 and decoding device 200 may generate a level of detail (referred to as a LoD, hereinafter) and encode or decode the motion vectors on a LoD basis. Alternatively, encoding device 100 and decoding device 200 may encode or decode the motion vectors in the encoding order or the decoding order of the position information of the three-dimensional points (that is, vertices) without generating LoD. Alternatively, encoding device 100 and decoding device 200 may generate Morton codes (Morton codes) using the position information of the three-dimensional points and encode or decode the motion vectors in the order of the Morton codes.

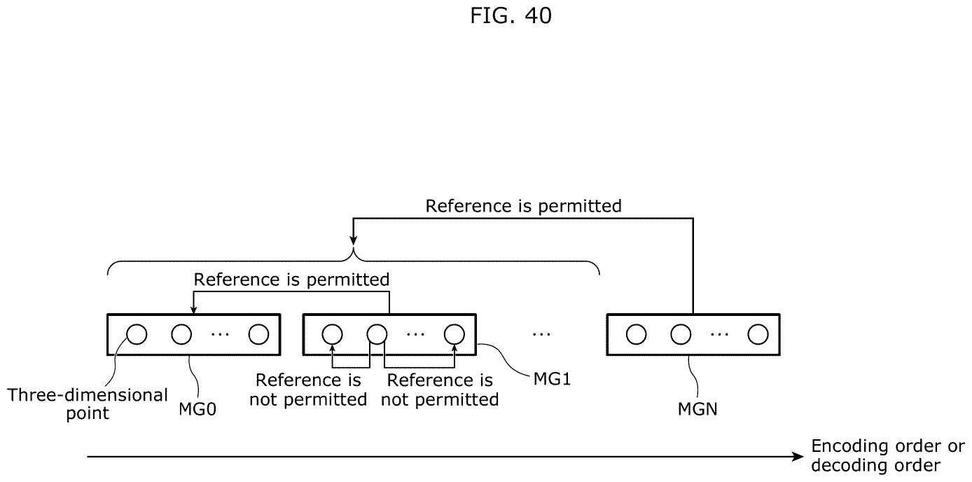

Next, with reference to FIGS. 40 to 42, specific examples of the motion group will be described. Note that in FIGS. 40, 42, and 43, MG0, MG1, and MGN denote examples of the motion group. Note that N denotes an integer equal to or greater than 2, for example, and the number of motion groups may be 2, or 3 or more. Furthermore, the plurality of three-dimensional points (specifically, information of the three-dimensional points) indicated by ◯ in the drawings are encoded or decoded from left. That is, the plurality of three-dimensional points illustrated in the drawings are sequentially encoded or decoded, beginning with the three-dimensional points belonging to the MG0. Furthermore, three-dimensional points belonging to the same MG are encoded or decoded from left.

FIG. 40 is a diagram illustrating a first example of reference destinations of motion groups according to the present embodiment.

In the first example, it is defined that the three-dimensional points belonging to the same motion group, or in other words, the three-dimensional points in the same motion group, cannot reference to each other. That is, in the first example, the motion vectors of the three-dimensional points belonging to the same group as the current three-dimensional point are not used for calculation of the prediction value of the motion vector of the current three-dimensional point. For example, the three-dimensional points in the same motion group are not added to adjacent points.

Furthermore, in the first example, the motion vectors of the three-dimensional points belonging to a different motion group than the current three-dimensional point are used for calculation of the prediction value of the motion vector of the current three-dimensional point. Specifically, in the first example, it is defined that encoded or decoded three-dimensional points in a different motion group can be referenced. That is, in the first example, the motion vectors of encoded or decoded three-dimensional points among the three-dimensional points belonging to a different motion group than the current three-dimensional point are used for calculation of the prediction value of the motion vector of the current three-dimensional point.

For example, in the example illustrated in FIG. 40, for calculation of the prediction value of the motion vector of a current three-dimensional point belonging to MG1, the motion vectors of the three-dimensional points belonging to MG1 are not used, and the motion vector of the three-dimensional points belonging to MG0 are used. Furthermore, in the example illustrated in FIG. 40, for calculation of the prediction value of the motion vector of the current three-dimensional point belonging to MG1, the motion vectors of the three-dimensional points belonging to MGN (specifically, MGN in the case where N is an integer equal to or greater than 2) are not used.

As described above, for example, encoded or decoded three-dimensional points in a different motion group are added to adjacent points.

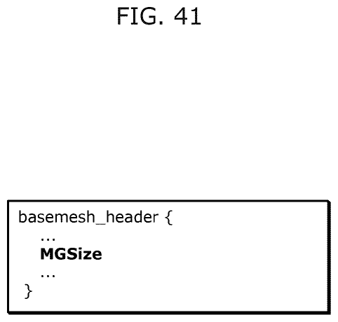

FIG. 41 is a diagram illustrating an example of a syntax of a base mesh header according to the present embodiment.

As with the syntax illustrated in FIG. 41, the size (data size) of the motion group may be described in the header of the bitstream or the like. For example, when the size (MGSize) of the motion group is 16, encoding device 100 may add MGSize=16 to the header of the bitstream. Alternatively, provided that MGSize is 2ⁿ (n: an integer equal to or greater than 0), encoding device 100 may add the value of n to the header of the bitstream.

Note that encoding device 100 and decoding device 200 may encode or decode the three-dimensional points in the same motion group in parallel.

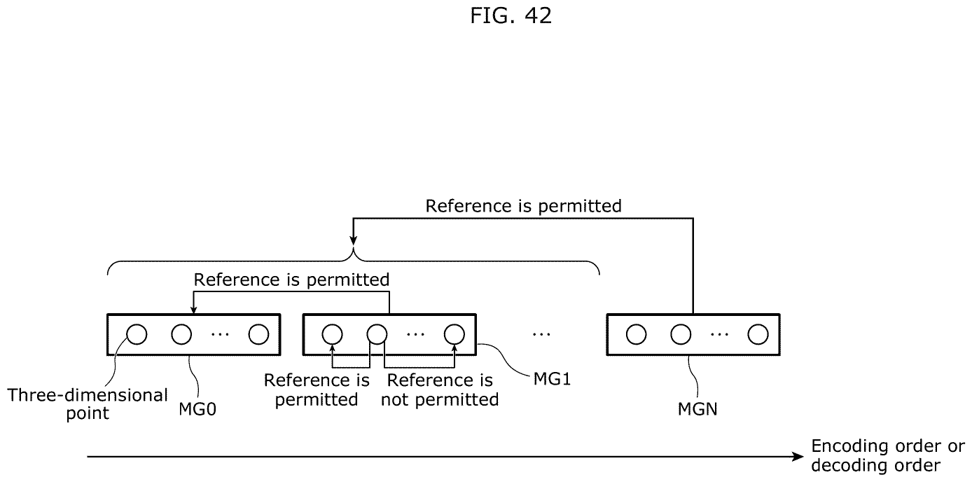

FIG. 42 is a diagram illustrating a second example of reference destinations of motion groups according to the present embodiment.

In the second example, it is defined that encoded or decoded three-dimensional points in the same motion group can be referenced. In the second example, it is also defined that encoded or decoded three-dimensional points in a different motion group can be referenced. In the second example, it is also defined that three-dimensional points yet to be encoded or decoded cannot be referenced. That is, in the second example, only the motion vector of already encoded or decoded three-dimensional points are used for calculation of the prediction value of the motion vector of the current three-dimensional point. For example, encoded or decoded three-dimensional points in the same motion group may be added to adjacent points. Furthermore, for example, encoded or decoded three-dimensional points in a different motion group may be added to adjacent points. On the other hand, for example, three-dimensional points yet to be encoded or decoded are not added to adjacent points, whether the three-dimensional points are in the same motion group or in a different motion group.

In the example illustrated in FIG. 42, for example, the motion vectors of encoded or decoded three-dimensional points among the three-dimensional points belonging to MG1 may be used for calculation of the prediction value of the motion vector of a current three-dimensional point belonging to MG1, while the motion vectors of three-dimensional points yet to be encoded or decoded are not used. Furthermore, in the example illustrated in FIG. 42, the motion vectors of the three-dimensional points belonging to MG0 may be used for calculation of the prediction value of the motion vector of the current three-dimensional point belonging to MG1, while the motion vectors of the three-dimensional points belonging to MGN (specifically, MGN in the case where N is an integer equal to or greater than 2) are not used.

Note that in the second example, again, the size of the motion group may be described in the header of the bitstream or the like. For example, when the size (MGSize) of the motion group is 16, encoding device 100 may add MGSize=16 to the header of the bitstream. Alternatively, provided that MGSize is 2ⁿ, encoding device 100 may add the value of n to the header of the bitstream.

As described above, by defining that three-dimensional points in the same motion group can also be referenced if the three-dimensional points are already encoded or decoded, the prediction precision can be improved, and the encoding efficiency can be improved.

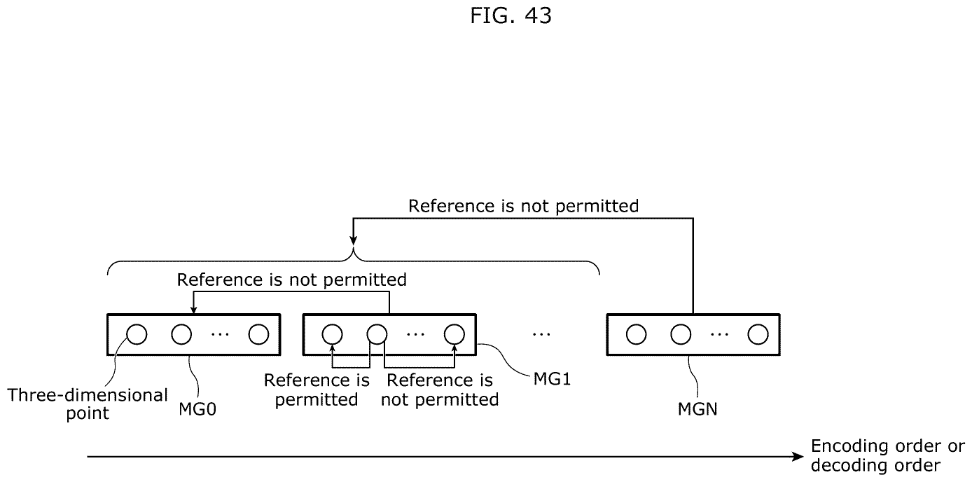

FIG. 43 is a diagram illustrating a third example of reference destinations of motion groups according to the present embodiment.

In the third example, it is defined that encoded or decoded three-dimensional points in the same motion group can be referenced. In the third example, however, it is defined that three-dimensional points yet to be encoded or decoded cannot be referenced. For example, encoded or decoded three-dimensional points in the same motion group may be added to adjacent points. On the other hand, for example, three-dimensional points yet to be encoded or decoded are not added to adjacent points even if the three-dimensional points are in the same motion group.

Furthermore, in the third example, it is defined that the three-dimensional points in a different motion group cannot be referenced. For example, the three-dimensional points in a different motion group are not added to adjacent points.

In the example illustrated in FIG. 43, for example, among the three-dimensional points belonging to MG1, the motion vectors of encoded or decoded three-dimensional points may be used for calculation of the prediction value of the motion vector of a current three-dimensional point belonging to MG1, while the motion vectors of three-dimensional points yet to be encoded or decoded are not used. Furthermore, in the example illustrated in FIG. 43, the motion vectors of the three-dimensional points belonging to a motion group other than MG1 are not used for calculation of the prediction value of the motion vector of the current three-dimensional point belonging to MG1.

Note that in the third example, again, the size of the motion group may be described in the header of the bitstream or the like. For example, when the size (MGSize) of the motion group is 16, encoding device 100 may add MGSize=16 to the header of the bitstream. Alternatively, provided that MGSize is 2ⁿ, encoding device 100 may add the value of n to the header of the bitstream.

As described above, by prohibiting reference between motion groups and making the motion groups independent from each other, encoding device 100 and decoding device 200 can encode or decode information of three-dimensional points in a plurality of motion groups in parallel.

Furthermore, by defining that encoded or decoded three-dimensional points in the same motion group can be referenced as described above, the prediction precision can be improved, and the encoding efficiency can be improved.

Note that the number of three-dimensional points belonging to each motion group can be arbitrarily determined and is not particularly limited. In addition, the number of three-dimensional points belonging to each motion group may be the same as or different from the other groups.

Note that when a full mesh, which is a mesh yet to be divided into one or more submeshes, is encoded or decoded after being divided into one or more submeshes, encoding device 100 and decoding device 200 may divide the three-dimensional points in each submesh into motion groups in accordance with the encoding order or the decoding order, and encode or decode the motion vectors of the three-dimensional points on a motion group basis.

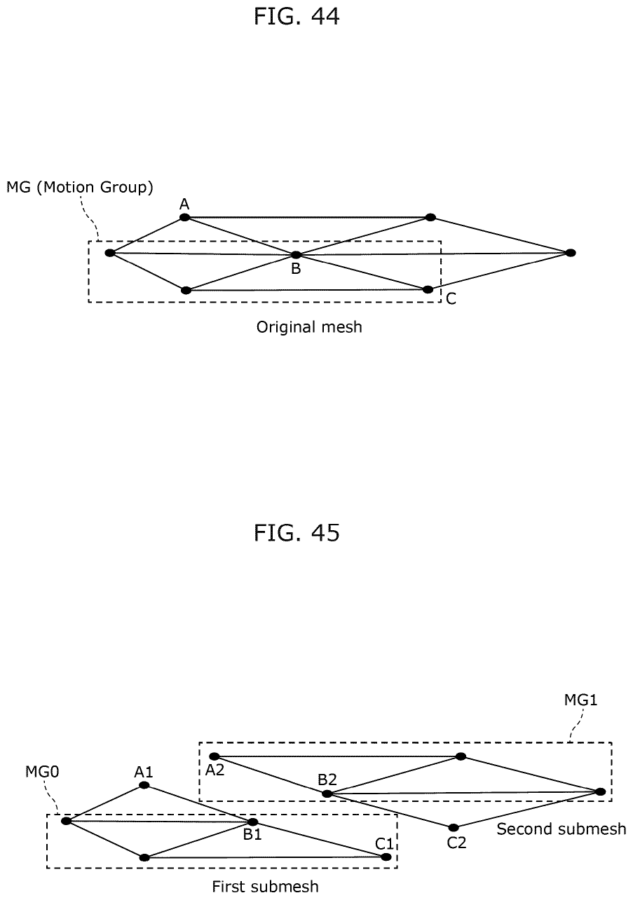

FIG. 44 is a diagram for describing a relationship between vertices forming a mesh (original mesh) and a motion group according to the present embodiment. FIG. 45 is a diagram for describing a relationship between vertices forming submeshes (a first submesh and a second submesh) and motion groups according to the present embodiment. Note that the first submesh and the second submesh illustrated in FIG. 45 are meshes produced by dividing the original mesh illustrated in FIG. 44.

In the example illustrated in FIGS. 44 and 45, three-dimensional points A, B, and C forming the original mesh (full mesh) are duplicated to form three-dimensional points A1, B1, and C1 forming the first submesh and three-dimensional points A2, B2, and C2 forming the second submesh, respectively, as a result of division of the original mesh into the submeshes. For example, encoding device 100 may allocate the motion vectors of three-dimensional points A1, B1, C1, A2, B2, and C2 to the motion groups in their respective submeshes to encode them in the method shown in the example described above.

In this way, encoding device 100 can encode the motion vectors of three-dimensional points in each submesh by selecting appropriate adjacent points from the three-dimensional points in the submesh while allocating the motion vectors to the motion group in the submesh.

Note that any three-dimensional point belonging to a submesh different from the submesh of the three-dimensional point to be encoded need not be included in adjacent points. In this way, since information is not referenced between submeshes, each submesh can be independently encoded or decoded.

Furthermore, three-dimensional points belonging to different submeshes need not be included in the same motion group. In this way, information can be prevented from being referenced between submeshes, and encoding device 100 and decoding device 200 can independently encode or decode each submesh.

As described above, for example, encoding device 100 and decoding device 200 determine, using distance information (information indicating the distance between three-dimensional points), vertices to be referenced in the process of predicting information of a vertex (current three-dimensional point) included in a three-dimensional mesh.

Furthermore, for example, the information of the vertex is a motion vector of vertex coordinates. It should be noted that the information of the vertex may be any information of a three-dimensional point such as position information or attribute information.

Furthermore, for example, the prediction process is an inter prediction process.

Furthermore, for example, encoding device 100 and decoding device 200 determine a combination of adjacent points.

Furthermore, for example, the distance information is a difference value between coordinates of a processing target point (current three-dimensional point) and coordinates of the adjacent points.

Furthermore, for example, encoding device 100 and decoding device 200 determine, as the adjacent points, vertices for which the difference value is less than or equal to a predetermined value.

Furthermore, for example, encoding device 100 and decoding device 200 determine, as the adjacent points, a predetermined number of vertices selected in an ascending order of their difference values.

Furthermore, for example, the predetermined number is encoded into a bitstream.

Furthermore, for example, the distance information is calculated using information of a reference frame.

Furthermore, for example, encoding device 100 and decoding device 200 derive the distance information by using a point corresponding to the processing target point included in the reference frame.

Furthermore, for example, the reference frame is a frame that precedes the processing target frame in display order.

Furthermore, for example, the reference frame is a frame that precedes the processing target frame in encoding order or decoding order.

Furthermore, for example, information other than the distance information is derived using information of the processing target frame.

Furthermore, for example, encoding device 100 and decoding device 200 selects a point having connectivity, by using the processing target point included in the processing target frame.

Furthermore, for example, encoding device 100 and decoding device 200 determine the adjacent points by using other information in addition to the distance information. It should be noted that the one or more other information to be used together with the distance information may be arbitrarily combined and used.

Furthermore, for example, encoding device 100 and decoding device 200 determine, as the adjacent points, vertices having connectivity with the processing target point.

Furthermore, for example, encoding device 100 and decoding device 200 determine, as adjacent points, vertices encoded or decoded before the processing target point. For example, encoding device 100 determines, as adjacent points, vertices encoded before the processing target point (three-dimensional point to be encoded). Furthermore, for example, decoding device 200 determines, as adjacent points, vertices decoded before the processing target point (three-dimensional point to be decoded).

Furthermore, for example, encoding device 100 and decoding device 200 determine, as adjacent points, vertices belonging to the same submesh as the processing target point.

Furthermore, for example, encoding device 100 and decoding device 200 determine, as adjacent points, vertices belonging to the same motion group as the processing target point.

Furthermore, for example, encoding device 100 and decoding device 200 determine, as adjacent points, vertices belonging to a different motion group than the processing target point.

Furthermore, for example, when the number of vertices that are adjacent point candidates is greater than a predetermined value, encoding device 100 and decoding device 200 select a predetermined number of vertices from among the candidate vertices in at least any of the methods described above.

### Representative Example

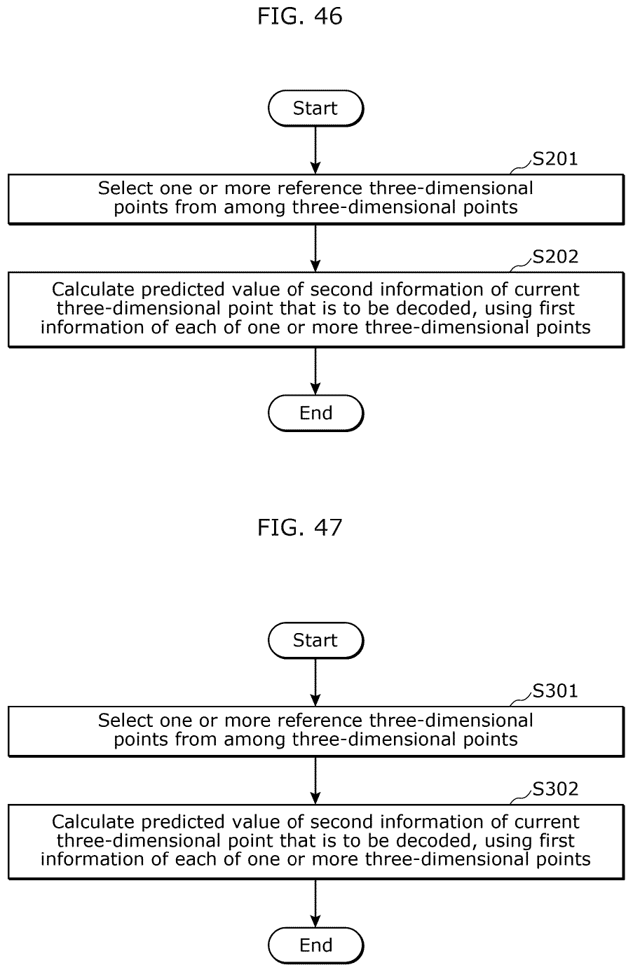

FIG. 46 is a flowchart illustrating an example of a basic encoding process according to the present embodiment. For example, circuit 151 of encoding device 100 illustrated in FIG. 24, in operation, performs the encoding process illustrated in FIG. 46.

Encoding device 100 executes an encoding method for encoding information of a three-dimensional point in a current frame to be encoded.

First, encoding device 100 selects one or more reference three-dimensional points from among three-dimensional points in a current frame (S201).

Next, encoding device 100 calculates, using first information of each of the one or more reference three-dimensional points, a predicted value of second information of a current three-dimensional point to be encoded in the current frame (S202).

Here, when selecting the one or more reference three-dimensional points (S201), encoding device 100 selects the one or more reference three-dimensional points, based on distances between the current three-dimensional point and each of the three-dimensional points.

The first information and the second information are information (specifically, prediction information) indicating a motion vector, for example. Each of the first information and the second information can be any information of a three-dimensional point, such as position information or attribute information. Furthermore, the reference three-dimensional point is the adjacent point described above, for example. Furthermore, the three-dimensional point is the vertex described above, for example. That is, the reference three-dimensional point is a point that is referenced to predict information of a three-dimensional point (vertex) to be encoded in a three-dimensional point cloud or a three-dimensional mesh and is selected under a condition. The condition may be the conditions described above, for example. One condition may be used or a plurality of conditions may be used in combination for selecting reference three-dimensional points. Furthermore, each of the plurality of three-dimensional points and the current three-dimensional point in the current frame is a vertex forming a three-dimensional mesh included in the current frame or a three-dimensional point forming a three-dimensional point cloud, for example. The current frame is the present frame described above, for example. Note that the information of the plurality of three-dimensional points and the current three-dimensional point need not include connection information. That is, the three-dimensional point cloud encoded by encoding device 100 may or may not be a three-dimensional mesh.

It is considered that, as the distance between three-dimensional points is closer, the information of the three-dimensional points will also be closer. For this reason, for example, the distance from the current three-dimensional point may be used as a condition in selecting a reference three-dimensional point. For example, it is considered that, by calculating the predicted value using, as the reference three-dimensional point, a three-dimensional point that is close to a current three-dimensional point, the prediction residual can be reduced. If the prediction residual can be reduced, the amount of code of a bitstream including information on the prediction residual can be reduced. Therefore, by selecting one or more reference three-dimensional points, based on the distances between the current three-dimensional point and each of the three-dimensional points, encoding device 100 can reduce the code amount.

Furthermore, for example, encoding device 100 calculates a prediction residual that is the difference between the predicted value and the value indicated by the second information, and generates a bitstream including prediction residual information indicating the prediction residual calculated. For example, encoding device 100 calculates the prediction residual after executing step S202, and further generates the bitstream.

The prediction residual is, for example, the above-described difference absolute value Diffp, and the prediction residual information is, for example, information indicating the difference absolute value Diffp.

Accordingly, encoding device 100 can generate a bitstream having reduced code amount.

Furthermore, for example, the first information of each of the one or more reference three-dimensional points indicates a motion vector of each of the one or more reference three-dimensional points, and the second information indicates a motion vector of the current three-dimensional point.

Specifically, the first information is information indicating a motion vector that indicates the amount of displacement from the coordinates of a three-dimensional point in the reference frame that corresponds to a reference three-dimensional point to the coordinates of the reference three-dimensional point in the current frame. The second information is information indicating a motion vector that indicates the amount of displacement from the coordinates of a three-dimensional point in the reference frame that corresponds to the current three-dimensional point to the coordinates of the current three-dimensional point in the current frame. The first information and the second information are the prediction information described above, for example. The reference frame is the past frame described above, for example.

Accordingly, encoding device 100 can encode the motion vectors.

Furthermore, for example, in the calculating of the predicted value (S202), encoding device 100 calculates the predicted value by using inter prediction. In other words, encoding device 100 calculates the predicted value by using information of a frame of a time different from the current frame.

Accordingly, encoding device 100 can calculate the predicted value.

Furthermore, for example, in the selecting of the one or more reference three-dimensional points, encoding device 100 calculates the distances by calculating the difference between coordinates of the current three-dimensional point and coordinates of each of the three-dimensional points.

Accordingly, encoding device 100 can calculate the distances between the current three-dimensional point and each of the three-dimensional points.

Furthermore, for example, in the selecting of the one or more reference three-dimensional points, encoding device 100 selects one or more three-dimensional points for which the distances are less than or equal to a predetermined value, as the one or more reference three-dimensional points, from among the three-dimensional points.

The predetermined value is, for example, the above-described threshold THd. The predetermined value may be determined arbitrarily in advance, and is not particularly limited.

Accordingly, encoding device 100 can select a three-dimensional point that is close to the current three-dimensional point, from among the three-dimensional points.

Furthermore, for example, in the selecting of the one or more reference three-dimensional points, encoding device 100 selects the one or more reference three-dimensional points by selecting, from among the three-dimensional points, a predetermined number of three-dimensional points in an ascending order of the distances.

Accordingly, encoding device 100 can select an appropriate number of reference three-dimensional points for calculating the predicted value.

Furthermore, for example, encoding device 100 generates a bitstream including predetermined number information indicating the predetermined number. For example, encoding device 100 generates a bitstream including prediction residual information and the predetermined number information.

The predetermined number is, for example, the above-described maximum adjacent point count (NumNeiCnt).

Accordingly, decoding device 200 can select reference three-dimensional points by using the predetermined number information obtained from the bitstream.

Furthermore, for example, in the selecting of the one or more reference three-dimensional points, encoding device 100 calculates the distances by using coordinates of a three-dimensional point corresponding to the current three-dimensional point, in a reference frame.

Accordingly, decoding device 200 can calculate the distances in the same manner as encoding device 100, without having to decode the coordinates of the current three-dimensional point in the current frame.

Furthermore, for example, the reference frame is a frame that precedes the current frame in display order.

Accordingly, encoding device 100 can encode the current frame by using a frame to be displayed in a display device earlier than the current frame, that is, by using a past frame.

Furthermore, for example, the reference frame is a frame that precedes the current frame in encoding order.

Accordingly, encoding device 100 can encode the current frame by using an encoded frame.

Furthermore, for example, in the selecting of the one or more reference three-dimensional points, encoding device 100 selects the one or more reference three-dimensional points by using the distances and information other than the distances. In other words, as a condition used in selecting a reference three-dimensional point, information other than the distance from the current three-dimensional point can be used.

The information other than the distance is, for example, connection information (connectivity). The information other than the distance may be, for example, the above-described threshold THd, the above-described NumNeiCnt, and/or information regarding the above-described motion group, and so on.

Accordingly, by appropriately selecting the information other than the distance, encoding device 100 can further reduce the code amount.

Furthermore, for example, the information other than the distances is connection information indicating whether the current three-dimensional point is connected to each of the three-dimensional points, and, in the selecting of the one or more reference three-dimensional points, encoding device 100 selects one or more three-dimensional points that are connected to the current three-dimensional point, among the three-dimensional points, as the one or more reference three-dimensional points.

In the case of three-dimensional points that are connected, it is considered that the information of such three-dimensional points will also be closer compared to three-dimensional points that are not connected. For this reason, for example, since it is considered that, by calculating the predicted value using, as the reference three-dimensional point, a three-dimensional point that is connected to the current three-dimensional point, the prediction residual can be reduced, and thus encoding device 100 can further reduce the code amount.

FIG. 47 is a flowchart illustrating an example of a basic decoding process according to the present embodiment. For example, circuit 251 of decoding device 200 illustrated in FIG. 25, in operation, performs the decoding process illustrated in FIG. 47. Decoding device 200 executes a decoding method for decoding information of a three-dimensional point in a current frame to be decoded.

First, decoding device 200 selects one or more reference three-dimensional points from among three-dimensional points in the current frame (S301).

Next, decoding device 200 calculates, using first information of each of the one or more reference three-dimensional points, a predicted value of second information of a current three-dimensional point to be decoded in the current frame (S302).

Here, when selecting the one or more reference three-dimensional points (S301), decoding device 200 selects the one or more reference three-dimensional points, based on distances between the current three-dimensional point and each of the three-dimensional points.

It is considered that, as the distance between three-dimensional points is closer, the information of the three-dimensional points will also be closer. For this reason, for example, it is considered that, by calculating the predicted value using, as the reference three-dimensional point, a three-dimensional point that is close to a current three-dimensional point, the prediction residual can be reduced. If the prediction residual can be reduced, the amount of code of a bitstream including information on the prediction residual can be reduced. Therefore, by selecting one or more reference three-dimensional points, based on the distances between the current three-dimensional point and each of the three-dimensional points, decoding device 200 can decode the information of the three-dimensional point by using information having reduced code amount.

Furthermore, for example, decoding device 200 obtains, from a bitstream, prediction residual information indicating a prediction residual; and calculates the second information, based on the prediction residual and the predicted value. For example, after step S302, decoding device 200 calculates the second information by using the prediction residual and the predicted value. The timing at which decoding device 200 obtains the prediction residual information may be arbitrary as long as it is before calculating the second information.

Accordingly, decoding device 200 can decode the information of the three-dimensional point by using information of the bitstream having reduced code amount.

Furthermore, the first information of each of the one or more reference three-dimensional points indicates a motion vector of each of the one or more reference three-dimensional points, and the second information indicates a motion vector of the current three-dimensional point.

Accordingly, decoding device 200 can decode the motion vectors.

Furthermore, for example, in the calculating of the predicted value (S302), decoding device 200 calculates the predicted value by using inter prediction.

Accordingly, decoding device 200 can calculate the predicted value.

Furthermore, for example, in the selecting of the one or more reference three-dimensional points, decoding device 200 calculates the distances by calculating the difference between coordinates of the current three-dimensional point and coordinates of each of the three-dimensional points.

Accordingly, decoding device 200 can calculate the distances between the current three-dimensional point and each of the three-dimensional points.

Furthermore, for example, in the selecting of the one or more reference three-dimensional points, decoding device 200 selects one or more three-dimensional points for which the distances are less than or equal to a predetermined value, as the one or more reference three-dimensional points, from among the three-dimensional points.

Accordingly, decoding device 200 can select a three-dimensional point that is close to the current three-dimensional point, from among the three-dimensional points.

Furthermore, for example, in the selecting of the one or more reference three-dimensional points, decoding device 200 selects the one or more reference three-dimensional points by selecting, from among the three-dimensional points, a predetermined number of three-dimensional points in an ascending order of the distances.

Accordingly, decoding device 200 can select an appropriate number of reference three-dimensional points for calculating the predicted value.

Furthermore, for example, decoding device 200 may obtain predetermined number information from a bitstream. For example, decoding device 200 obtains the predetermined number information from the bitstream before step S301.

Accordingly, decoding device 200 can select the appropriate number of reference three-dimensional points for calculating the predicted value, by using the predetermined number information obtained from the bitstream.

Furthermore, for example, in the selecting of the one or more reference three-dimensional points, decoding device 200 calculates the distances by using coordinates of a three-dimensional point corresponding to the current three-dimensional point, in a reference frame.

Accordingly, decoding device 200 can calculate the distances in the same manner as encoding device 100, without having to decode the coordinates of the current three-dimensional point in the current frame.

Furthermore, for example, the reference frame is a frame preceding the current frame in display order.

Accordingly, decoding device 200 can decode the current frame by using a frame to be displayed in a display device earlier than the current frame, that is, by using a past frame.

Furthermore, for example, the reference frame is a frame preceding the current frame in decoding order.

Accordingly, decoding device 200 can decode the current frame by using a decoded frame.

Furthermore, for example, in the selecting of the one or more reference three-dimensional points, decoding device 200 selects the one or more reference three-dimensional points by using the distances and information other than the distances

Accordingly, by appropriately selecting the information other than the distance, decoding device 200 can decode the information of the three-dimensional point by using information having a further reduced code amount.

Furthermore, for example, the information other than the distances is connection information indicating whether the current three-dimensional point is connected to each of the three-dimensional points, and, in the selecting of the one or more reference three-dimensional points, decoding device 200 selects one or more three-dimensional points that are connected to the current three-dimensional point, among the three-dimensional points, as the one or more reference three-dimensional points.

In the case of three-dimensional points that are connected, it is considered that the information of such three-dimensional points will also be closer compared to three-dimensional points that are not connected. For this reason, for example, since it is considered that, by calculating the predicted value using, as the reference three-dimensional point, a three-dimensional point that is connected to the current three-dimensional point, the prediction residual can be reduced, and thus decoding device 200 can decode the information of the three-dimensional point by using information having a further reduced code amount.

### Other Examples

Although the aspects of encoding device 100 and decoding device 200 have thus far been described according to the embodiment, the aspects of encoding device 100 and decoding device 200 are not limited to the embodiment. Modifications that may be conceived by a person skilled in the art may be applied to the embodiment, and a plurality of constituent elements in the embodiment may be combined in any manner.

For example, processing performed by a specific constituent element in the embodiment may be performed by a different constituent element instead of the specific constituent element. Moreover, the order of processes may be changed or processes may be performed in parallel.

Moreover, as stated above, it is possible to implement, as an integrated circuit, at least part of the plurality of constituent elements in the present disclosure. At least part of the processes in the present disclosure may be used as an encoding method or a decoding method. A program for causing a computer to execute the encoding method or the decoding method may be used. Furthermore, a non-transitory computer-readable recording medium on which the program is recorded may be used. In addition, a bitstream for causing decoding device 200 to perform decoding may be used.

Moreover, at least part of the plurality of constituent elements and the processes in the present disclosure may be used as a transmitting device, a receiving device, a transmitting method, and a receiving method. A program for causing a computer to execute the transmitting method or the receiving method may be used. Furthermore, a non-transitory computer-readable recording medium on which the program is recorded may be used.

### INDUSTRIAL APPLICABILITY

The present disclosure is useful in an encoding device, a decoding device, a transmitting device, a receiving device, and the like, related to a three-dimensional mesh, and is applicable to a computer graphics system, a three-dimensional data display system, and the like.

1. An encoding method for encoding information of a three-dimensional point in a current frame to be encoded, the encoding method comprising:
selecting one or more reference three-dimensional points from among three-dimensional points in the current frame; and
calculating, using first information of each of the one or more reference three-dimensional points, a predicted value of second information of a current three-dimensional point to be encoded in the current frame, wherein
in the selecting of the one or more reference three-dimensional points, the one or more reference three-dimensional points are selected based on distances between the current three-dimensional point and each of the three-dimensional points.

2. The encoding method according to claim 1, further comprising:
calculating a prediction residual that is a difference between a value indicated by the second information and the predicted value; and
generating a bitstream that includes prediction residual information indicating the prediction residual calculated.

3. The encoding method according to claim 1, wherein
the first information of each of the one or more reference three-dimensional points indicates a motion vector of each of the one or more reference three-dimensional points, and
the second information indicates a motion vector of the current three-dimensional point.

4. The encoding method according to claim 1, wherein
in the calculating of the predicted value, the predicted value is calculated using inter prediction.

5. The encoding method according to claim 1, wherein
in the selecting of the one or more reference three-dimensional points, the distances are calculated by calculating a difference between coordinates of the current three-dimensional point and coordinates of each of the three-dimensional points.

6. The encoding method according to claim 1, wherein
in the selecting of the one or more reference three-dimensional points, one or more three-dimensional points for which the distances are less than or equal to a predetermined value are selected as the one or more reference three-dimensional points, from among the three-dimensional points.

7. The encoding method according to claim 1, wherein
in the selecting of the one or more reference three-dimensional points, the one or more reference three-dimensional points are selected by selecting, from among the three-dimensional points, a predetermined number of three-dimensional points in an ascending order of the distances.

8. The encoding method according to claim 1, wherein
in the selecting of the one or more reference three-dimensional points, the distances are calculated using coordinates of a three-dimensional point corresponding to the current three-dimensional point, in a reference frame.

9. The encoding method according to claim 1, wherein
in the selecting of the one or more reference three-dimensional points, the one or more reference three-dimensional points are selected using the distances and information other than the distances.

10. The encoding method according to claim 9, wherein
the information other than the distances is connection information indicating whether the current three-dimensional point is connected to each of the three-dimensional points, and
in the selecting of the one or more reference three-dimensional points, one or more three-dimensional points that are connected to the current three-dimensional point, among the three-dimensional points, are selected as the one or more reference three-dimensional points.

11. A decoding method for decoding information of a three-dimensional point in a current frame to be decoded, the decoding method comprising:
selecting one or more reference three-dimensional points from among three-dimensional points in the current frame; and
calculating, using first information of each of the one or more reference three-dimensional points, a predicted value of second information of a current three-dimensional point to be decoded in the current frame, wherein
in the selecting of the one or more reference three-dimensional points, the one or more reference three-dimensional points are selected based on distances between the current three-dimensional point and each of the three-dimensional points.

12. The decoding method according to claim 11, further comprising:
obtaining, from a bitstream, prediction residual information indicating a prediction residual; and
calculating the second information, based on the prediction residual and the predicted value.

13. The decoding method according to claim 11, wherein
the first information of each of the one or more reference three-dimensional points indicates a motion vector of each of the one or more reference three-dimensional points, and
the second information indicates a motion vector of the current three-dimensional point.

14. The decoding method according to claim 11, wherein
in the calculating of the predicted value, the predicted value is calculated using inter prediction.

15. The decoding method according to claim 11, wherein
in the selecting of the one or more reference three-dimensional points, the distances are calculated by calculating a difference between coordinates of the current three-dimensional point and coordinates of each of the three-dimensional points.

16. The decoding method according to claim 11, wherein
in the selecting of the one or more reference three-dimensional points, one or more three-dimensional points for which the distances are less than or equal to a predetermined value are selected as the one or more reference three-dimensional points, from among the three-dimensional points.

17. The decoding method according to claim 11, wherein
in the selecting of the one or more reference three-dimensional points, the one or more reference three-dimensional points are selected by selecting, from among the three-dimensional points, a predetermined number of three-dimensional points in an ascending order of the distances.

18. The decoding method according to claim 11, wherein
in the selecting of the one or more reference three-dimensional points, the distances are calculated using coordinates of a three-dimensional point corresponding to the current three-dimensional point, in a reference frame.

19. The decoding method according to claim 11, wherein
in the selecting of the one or more reference three-dimensional points, the one or more reference three-dimensional points are selected using the distances and information other than the distances.

20. The decoding method according to claim 19, wherein
the information other than the distances is connection information indicating whether the current three-dimensional point is connected to each of the three-dimensional points, and
in the selecting of the one or more reference three-dimensional points, one or more three-dimensional points that are connected to the current three-dimensional point, among the three-dimensional points, are selected as the one or more reference three-dimensional points.

21. An encoding device that encodes information of a three-dimensional point in a current frame to be encoded, the encoding device comprising:
memory; and
a circuit having access to the memory, wherein
in operation, the circuit:
selects one or more reference three-dimensional points from among three-dimensional points in the current frame; and
calculates, using first information of each of the one or more reference three-dimensional points, a predicted value of second information of a current three-dimensional point to be encoded in the current frame, and
when selecting the one or more reference three-dimensional points, the circuit selects the one or more reference three-dimensional points, based on distances between the current three-dimensional point and each of the three-dimensional points.

22. A decoding device that decodes information of a three-dimensional point in a current frame to be decoded, the decoding device comprising:
memory; and
a circuit capable of accessing the memory, wherein
in operation, the circuit:
selects one or more reference three-dimensional points from among three-dimensional points in the current frame; and
calculates, using first information of each of the one or more reference three-dimensional points, a predicted value of second information of a current three-dimensional point to be decoded in the current frame, and
when selecting the one or more reference three-dimensional points, the circuit selects the one or more reference three-dimensional points, based on distances between the current three-dimensional point and each of the three-dimensional points.
